(19) United States
(12) Patent Application Publication
(10) Pub. No.: US 2023/0368114 A1
(43) Pub. Date: Nov. 16, 2023

(54) SYSTEMS AND METHODS FOR LOGISTICS FACILITY MANAGEMENT

(71) Applicant: United States Postal Service, Washington, DC (US)

(72) Inventors: Ernest A. Onody, Washington, DC (US); Shannon Burgard, Washington, DC (US); Saul Coelho, Washington, DC (US)

(21) Appl. No.: 18/316,164

(22) Filed: May 11, 2023

Related U.S. Application Data
(60) Provisional application No. 63/364,612, filed on May 12, 2022.

(51) Int. Cl. G06Q 10/0639; G06Q 10/08

(52) U.S. Cl. CPC G06Q 10/06393; G06Q 10/08

(57) ABSTRACT

A system may include a database comprising a key performance indicator associated with a facility and a memory storing computer-executable instructions. A system may include one or more processors in communication with the memory, wherein the computer-executable instructions when executed by the one or more processors cause the one or more processors to receive, from the database, the key performance indicator. Process the key performance indicator to assign a site risk index of the facility by comparing the key performance indicator to an expected value. Determine, based on the site risk index, a requirement to implement an action plan associated with a facility issue. Generate, based on the key performance indicator and the site risk index, the action plan comprising a remedial action, wherein the action plan corrects the facility issue. Transmit the remedial action to an equipment, wherein the remedial action comprises an action performable by the equipment.

### RELATED APPLICATIONS

This application claims priority to and the benefit of Provisional Application No. 63/364,612 filed on May 12, 2022, in the U.S. Patent and Trademark Office, the entire content of which is incorporated herein by reference.

### BACKGROUND

The described technology generally relates to systems and methods for monitoring, analyzing, and managing a logistics network based on the determination of key performance indicators.

### SUMMARY

Some aspects described herein include a system comprising a key performance indicator associated with a facility, a memory storing computer-executable instructions, and one or more processors in communication with the memory. The computer-executable instructions, when executed by the one or more processors, cause the one or more processors to receive the key performance indicator from the database and process the key performance indicator to assign a site risk index of the facility by comparing the key performance indicator to an expected value. The computer-executable instructions when executed by the one or more processors further cause the one or more processors to determine a requirement to implement an action plan associated with a facility issue based on the site risk index and generate an action plan comprising a remedial action based on the key performance indicator and the site risk index. The action plan is generated to correct the facility issue. The computer-executable instructions when executed by the one or more processors further cause the one or more processors to transmit the remedial action to an equipment of the facility, and the remedial action plan comprises an action performance by the equipment.

In one aspect, the techniques described herein relate to a method including: receiving, from a database, a key performance indicator associated with a facility; processing the key performance indicator to assign a site risk index of the facility by comparing the key performance indicator to an expected value; determining, based on the site risk index, a need to implement an action plan to correct a facility issue; generating, based on the key performance indicator and the site risk index, the action plan including a remedial action to correct the facility issue; transmitting the remedial action to an equipment of the facility; and causing the equipment to implement the remedial action.

In another aspect described herein, a system comprises a database comprising a key performance indicator associated with a facility; a memory storing computer-executable instructions; one or more processors in communication with the memory, wherein the computer-executable instructions when executed by the one or more processors cause the one or more processors to: receive, from the database, the key performance indicator; process the key performance indicator to assign a site risk index of the facility by comparing the key performance indicator to an expected value; determine, based on the site risk index, a requirement to implement an action plan associated with a facility issue; generate, based on the key performance indicator and the site risk index, the action plan comprising a remedial action, wherein the action plan corrects the facility issue; and transmit the remedial action to an equipment of the facility, wherein the remedial action comprises an action performable by the equipment.

In some embodiments, the one or more processors are further configured to automatically instruct the equipment to alter one or more operations in response to the determined site risk index.

In some embodiments, the response further comprises a user approval and user adjustment associated with the action plan; and wherein the one or more processors are further programmed by the computer-executable instructions to modify the action plan based on the user adjustment.

In some embodiments, the one or more processors are further programmed by the computer-executable instructions to: receive, from the database, an updated key performance indicator associated with the facility responsive to the remedial action; process the updated key performance indicator to assign an updated site risk index of the facility by comparing the updated key performance indicator to the expected value; determine, based on the updated site risk index, a need to implement an updated action plan; generate, based on the updated site risk index and the updated key performance indicator, the updated action plan; and transmit the updated action plan to the equipment.

In some embodiments, the database comprises a plurality of key performance indicators, each key performance indicator of the plurality of key performance indicators associated with at least one of a plurality of facilities.

In some embodiments, the one or more processors are further programmed by the computer-executable instructions to: transmit an alert to a user, the alert comprising an indication that the remedial action has been transmitted to the equipment.

In some embodiments, the action plan is generated based in part on a previously implemented action plan.

In some embodiments, the system further comprises a plurality of equipment associated with the facility, the plurality of equipment in communication with the database.

In some embodiments, the site risk index indicates a likelihood of a delay in the processing of mail by the facility.

In another aspect described herein, a method comprises receiving, from a database, a key performance indicator associated with a facility; processing the key performance indicator to assign a site risk index of the facility by comparing the key performance indicator to an expected value; determining, based on the site risk index, a need to implement an action plan to correct a facility issue; generating, based on the key performance indicator and the site risk index, the action plan comprising a remedial action to correct the facility issue; transmitting the remedial action to an equipment of the facility; and causing the equipment to implement the remedial action.

In some embodiments, the method further comprises: receiving, at the database, an information item from a facility equipment; and generating, based at least on the information item, the key performance indicator.

In some embodiments, the method further comprises: generating, based at least on the site risk index and the key performance indicator, a user interface comprising the site risk index and the key performance indicator; and presenting the user interface on a display.

In some embodiments, the method further comprises receiving via the user interface a user indication; adjusting the action plan in response to the user indication by changing the remedial action to create an updated remedial action; transmitting the updated remedial action to the equipment; and causing the equipment to implement the updated remedial action.

In some embodiments, the method further comprises receiving a response from the equipment indicating performance of the remedial action; and updating the user interface based on the response.

In some embodiments, the method further comprises receiving, via the user interface, a user request comprising a request to display information of a second facility; receiving, from a second database, a second key performance indicator associated with the second facility; processing the second key performance indicator to assign a second site risk index of the second facility by comparing the second key performance indicator to a second expected value; and causing the user interface to display the second site risk index and the second key performance indicator.

In some embodiments, the facility is of a first facility type and wherein the second facility is of a second facility type.

In some embodiments, the site risk index is a weighted score determined from a plurality of key performance indicators representing a current status of the facility.

in some embodiments, the facility is one of a network distribution center or a surface transfer center.

In some embodiments, the key performance indicator is an average container dwell time of the facility, and the method further comprises receiving from a camera of the facility a first image of the facility representing a location; identifying a plurality of trailers in the first image; determining a location of each of the plurality of trailers; receiving from the camera a second image of the facility, wherein the second image comprises image information of substantially the location as represented in the first image; identifying a second plurality of trailers in the second image; determining the location of each of the second plurality of trailers; comparing each trailer of the plurality of trailers to each trailer of the second plurality of trailers to generate a first result; comparing the location of each trailer of the plurality of trailers to each trailer of the second plurality of trailers to generate a second result; determining a number of trailers closed not loaded; assessing the number of trailers closed not loaded to a historical trailers closed not loaded to create a trend value; generating the key performance indicator based on the trend value; and storing the key performance indicator in the database.

In some embodiments, causing the equipment to implement the remedial action comprises automatically summoning an automated guided vehicle to pick up and move a container at the facility.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 is an example diagram of a system overview of a computing system implementing the Business Intelligence Capacity Model (“BICM”).

FIG. 2 is an example system overview diagram illustrating the facility-level generation of KPIs.

FIG. 3 is an example flow diagram for the generalized measurement and reporting of KPIs.

FIG. 4 is an example flow diagram for a delayed package inventory analyzer.

FIG. 5 is an example flow diagram for an average entry to first auto cycle time module.

FIG. 6 is an example flow diagram for a processed volume compared to current capacity analyzer.

FIG. 7 is an example flow diagram for a processed volume compared to daily average database.

FIG. 8 is an example flow diagram for a percent square footage used comparator.

FIG. 9 is an example flow diagram for a scheduled trips not departed tracking database.

FIG. 10 is an example flow diagram for a containers closed not loaded trend database.

FIG. 11 is an example flow diagram for a yard cycle time database.

FIG. 12 is an example flow diagram for a facility resource availability database.

FIG. 13 is an example flow diagram for a severely delayed packages in transit analyzer.

FIG. 14 is an example user interface layout for interfacing with the system.

FIG. 15 is an example flow diagram for the system to generate proposed solutions to issues detected through KPI reporting.

### DETAILED DESCRIPTION

Provided herein are various embodiments of systems and methods for monitoring, identifying, correcting, and improving item sorting, handling, and processing within a distribution or logistics network.

In the following detailed description, reference is made to the accompanying drawings, which form a part thereof. In the drawings, similar symbols typically identify similar components, unless context dictates otherwise. Thus, in some embodiments, part numbers may be used for similar components in multiple figures, or part numbers may vary depending from figure to figure. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and made part of this disclosure.

Systems and methods described herein can relate to improving the technical field of logistics, incorporating automatic systems to identify processes and potential delays, gridlock, or inefficiencies in a delivery facility or a delivery network. As an example, the specification describes a Business Intelligence Capacity Model (hereinafter “BICM”), which is a solution to modernize, update, automate, and improve a distribution or logistics network, including, for example, a distribution network's systems supporting processing facilities, transportation management, facility utilization, and future planning initiatives. The BICM is a dynamic risk assessment model integrating a range of key performance indicators collected from delivery facilities to assess current service levels across a logistics network. BICM's analysis of KPIs in real time allows for the generation of alerts and suggested service changes across the network to minimize the impact of unforeseen issues on delivery services.

A logistics network can distribute and/or deliver items to a plurality of geographic areas, which can be local or can be nationwide. The logistics network can use its delivery resources, such as vehicles, carriers, employees, and rolling stock can be identified within geographic areas, and this information can be provided to shippers, distributors, merchants, retailers, or any other group that may wish to deliver one item or bulk items to a geographic area. The logistics network can divide an area, such as a country, state, city, etc., into a plurality of geographic areas.

A logistics network may comprise multiple levels. For example, a logistics network may comprise regional distribution facilities, hubs, and unit delivery facilities, or any other desired level. For example, a nationwide logistics network may comprise one or more regional distribution facilities having a defined coverage area (such as a geographic area), designated to receive items from intake facilities within the defined coverage area, or from other regional distribution facilities. The regional distribution facility can sort items for delivery to another regional distribution facility, or to a hub level facility within the regional distributional facility's coverage area. A regional distribution facility can have one or more hub level facilities within its defined coverage area. A hub level facility can be affiliated with a few or many delivery facilities, and can sort and deliver items to the delivery facilities with which it is associated. In an exemplary distribution network, such as the United States Postal Service (USPS), the delivery facility may be associated with a ZIP Code. The delivery facility may receive items from local senders, and from hub level facilities or regional distribution facilities. The delivery facility may additionally sort and stage the items intended for delivery to destinations within the delivery facility's coverage area or to another delivery facility. Delivery resources, such as carriers, vehicles, containers, and the like, can travel routes to various delivery points. In some embodiments, the delivery resource can travel a fixed route, delivering to the same set of delivery points. The fixed routes are serviced each day, or on one or more days of the week. In some embodiments, the delivery resources may deliver to the delivery points on a dynamic, or ad hoc basis.

Delivery facilities of a logistics network may continuously, or at intervals, collect and update information about all aspects of delivery services provided by the facility. Comparing the current information with past and expected performance at both an individual facility level and a network level may allow for the creation and updating of KPIs which BICM can then process to produce suggested alternative, additional, or corrective actions. These KPIs can, for example include the time between a parcel arriving at a facility and being scanned for the first time, the amount of square footage available in a facility storage area, the number of employees expected to be working compared to actual staffing levels, the number of containers loaded for delivery but not on a delivery vehicle, the number of scheduled delivery trips not yet departed from the facility, the total cycle time for parcels, the currently processed volume compared to current processing capacity, the inventory level of delayed packages, and the volume of severely delayed packages. Any number of other KPIs reflecting information about the receipt, processing, and delivery of parcels may also be measured and incorporated into BICM's decision-making.

Alternative, additional, or corrective actions can include automatically summoning a delivery resource, such as an operator, a forklift, an automated guided vehicle (AGV), or other resource to move, remove, reposition, or process a delivery item, such as a container. In some embodiments, the system described herein can change a sort plan or a processing plan for one or more pieces of item processing equipment, such as mail sorters, etc., and change the route of items processed through the equipment based on the KPIs and predicted gridlock, backlogs, and the like.

As used herein, items and distribution items can be described as mail, mailpieces, parcels, or packages, along with other terms for describing embodiments of the present development. These terms are exemplary only, and the scope of the present disclosure is not limited to mail, mailpiece, parcel or postal applications.

As used herein, the term item or distribution item may also refer to an individual article, object, agglomeration of articles, or container having more than one article within, in a distribution system. The item may be a letter, magazine, flat, luggage, package, box, or any other item of inventory which is transported or delivered in a distribution system or network. The term item may also refer to a unit or object which is configured to hold one or more individual items, such as a container which holds multiple letters, magazines, boxes, etc. The term item may also include any object, container, storage area, rack, tray, truck, train car, airplane, or other similar device into which items or articles may be inserted and subsequently transported, as are commonly used in distribution and logistics systems and networks.

The embodiments disclosed herein each have several aspects no single one of which is solely responsible for the disclosure's desirable attributes. Without limiting the scope of this disclosure, its more prominent features will now be briefly discussed. After considering this discussion, and particularly after reading the section entitled “Detailed Description,” one will understand how the features of the embodiments described herein provide advantages over existing systems, devices, and methods for monitoring, analyzing, and managing a logistics network based on key performance indicators (hereinafter “KPIs”).

Logistics networks are made up of personnel and equipment spread across various types of processing and distribution facilities which may located across significant distances. These networks are complex, perform time-critical functions, and the current conditions at each facility can impact the performance of the entire network. Adjustments to the logistics network in response to unexpected delays, increased transport requirements, or other unknowns often lag behind impacts to the network which negatively impact service. The delay in responding to unexpected events is due, in part, to a lack of real-time monitoring and reporting of the status of logistics facilities to planners. This leads to inefficiencies in the network. As such, a need exists for a real-time monitoring and reporting system capable of assessing the current state of disparate equipment and personnel to provide the information necessary to rapidly respond to inefficiencies.

In some embodiments, the system may display a dashboard which can be used to visually display real-time or substantially real-time conditions. The dashboard may provide a single location to view all KPIs to see, for example, determined risk status, and to visually determine areas where issues are forming or have occurred. By examining KPIs and, in some examples, other operational parameters, issues can be identified in the early stages, before the issues create backlogs, staging or space problems, equipment failures or operational issues, shipment delays, inefficiencies, and other potential issues. Several operational indicators and metrics or KPIs can be evaluated to determine operational conditions at a facility. When issues are identified, appropriate alerts, notifications, and corrective actions can be taken. Visibility and operational information for facilities may be viewed and evaluated at a system wide, such as national, level, at a regional level, an individual level, or at any desired level. Operational parameters can be evaluated for each facility, each piece of equipment at each facility, each operator or other resource at each facility. The parameters can be analyzed individually, agglomerated for a facility, for a region, and/or for the logistics network as a whole.

Examples of issues may include, but are not limited to, an unplanned lack of employees available for processor or delivery, a breakdown of mechanical equipment (e.g., delivery vehicles, sorting vehicles, moving equipment, etc.), an unplanned maintenance event, a planned maintenance event, an electrical outage, a software bug or exception, a weather event (e.g., a snowstorm limiting the speed of transport of items between facilities), or any other planned or unplanned occurrence which may affect the rate of processing of items by a logistics network.

In some embodiments, input to the system may be received from various sources and systems within the logistics network, including sort plans, scanning and tracking modules, visibility reports, equipment operational information, camera feeds, timekeeping programs, and others. Additionally, input to the system may be received from users of the logistics network, or third parties associated with the logistics network. For example, a user may provide a manifest of items expected to be delivered to the logistics network for further delivery within a future timeframe, and the system may then create a volume forecast for the logistics network based in part on the manifest. The system will analyze each of the data sources to generate metrics for key performance indicators. Input may be generated manually, for example by an employee of the logistics network. In some embodiments, input may be generated automatically, for example by a camera system using machine learning models to identify or track aspects of the logistics network (e.g., machine utilization, item delivery times or locations, item movement within or between facilities, etc.).

In some embodiments, 10 key performance indicators can be evaluated and displayed on the dashboard. In some embodiments, any number of KPIs may be evaluated and displayed on the dashboard. The KPIs may be given an equal weighting when determining their impact on the logistics network. In some embodiments, some or all of the KPIs may have different weightings when used to determine an impact on the operations of the logistics network or any facility associated with the logistics network (e.g., a surface transport center).

In one example, the logistics network may be the United States Postal Service (USPS). Although some embodiments described herein refer to the USPS, this is exemplary only and need not be limited thereto. The system may provide and display in the dashboard current information on various KPIs for all USPS processing facilities and compute an overall index score to determine operational status. Additionally, information from third-party facilities may be processed to determine an operational status, efficiency, or potential network impact associated with the third-party facility. In the present example, each KPI contains a detailed tab where users can drill down into the specifics regarding each calculated metric. This visualization and customization may be designed to enable assessment of the risk of gridlock and allow the end user to leverage the data to make real time decisions to potentially offset the current trend of indicators being displayed. In some embodiments, alternative KPIs, or alternative numbers of KPIs, may be associated with different facilities. For example, a first facility (e.g., a surface transport center in a rural area) may display six KPIs in the visualization and use six KPIs for assessment of the first facility's status. Then, a second facility (e.g., a network distribution center in a dense urban area) may use ten KPIs, some or all of which may be different from the KPIs used for the first facility, in the visualization and assessment of the second facility's status.

Continuing the above example, the system may be refreshed each hour with the latest information from various data sources of a distribution network, including, for example, visibility systems, transportation systems, timeclocks, item tracking systems, and the like. This information may be used by the system to update the dashboard. In some embodiments, the system may be refreshed at any interval determined to assist the end user in leveraging the system to make real time decisions. These information databases are examples, and any information database may provide input to the system. As an example, 10 distinct performance indicators which are scored individually into separate status categories (contingency, mitigation, elevated, normal) based on their current levels may be provided by the system through the dashboard to the end user. Each of these measures may be color-coded based on their current status. An overall site risk index may then be determined based on a composite of all 10 indicators to create an overall status for each facility. This site risk index may also be color-coded, and its color may be used on a map display, or other display, to aid in the visualization of the status of the logistics network for the end user. In some embodiments, the site risk index is not a ranking of facilities, it is an individual risk score based on each site's current situation. The view may be sorted based on the highest risk sites automatically or in response to a request by the end user. In some embodiments, the overall site risk index may be determined based on a facility type. A particular type of facility, such as a processing center or hub may weight performance indicators differently than a local unit delivery facility or may use different or a subset of performance indicators to generate an overall risk index or risk score. In some embodiments, the corrective actions to be taken at a given risk index or risk value may be different depending on the identity of the facility.

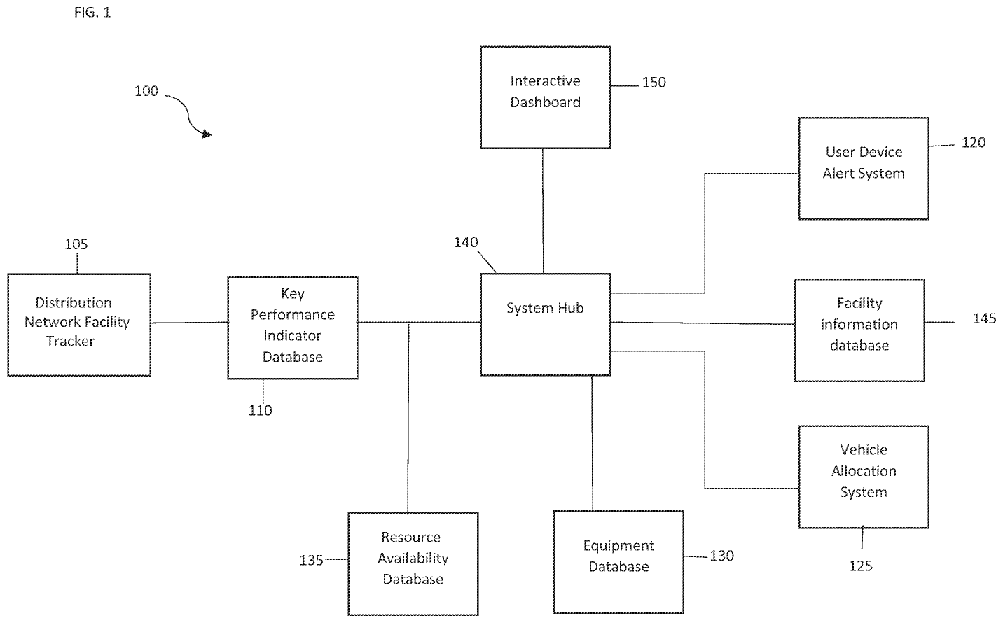

FIG. 1 is an illustrative system overview diagram of a system 100 showing an example architecture and connections making up the network structure. The system hub 140 may have access to system-wide reporting from a resource availability database 135, a user device alert system 120, a key performance indicator database 110, an equipment database 130, a facility information database 145, a vehicle allocation system 125, and an interactive dashboard 150. The system hub 140 may also send information to the connected systems to make updated requests, inform connected systems of changes to other systems to which system hub 140 has access (e.g., updating the vehicle allocation system 125 when there is a change to available drivers in the resource availability database 135), or redistribute personnel or equipment as part of a responsive action plan implemented in response to negative KPIs in the key performance indicator database 110.

The key performance indicator database 110 stores the KPIs for one or more delivery facilities and may receive its input from the distribution network facility tracker 105 for each delivery facility which is part of the logistics network. There may be a single key performance indicator database 110 aggregating all KPIs for the entire logistics network, for one facility, or for a plurality of facilities, such as a group of facilities in a geographic area, as shown. In some embodiments, there may be more than one key performance indicator database 110 with each key performance indicator database 110 connected to one or more delivery facilities. In some embodiments, system hub 140 may have direct access to one or more distribution network facility tracker 105 instead of or in addition to having access to the key performance indicator database 110 for the delivery facilities. KPIs will be described in greater detail herein.

The distribution network facility tracker 105 collects and analyzes information about the delivery facility's systems. Some or all of the information collected by the distribution network facility tracker 105 is used to generate values or scores for one or more KPIs which are transmitted to the at least one key performance indicator database 110. In some embodiments, the KPI comprises is a threshold, a range, a value, a score, or other quantitative criteria. The information tracked by the distribution network facility tracker 105 may include any information relevant to the functioning of a facility. For example, the number of processing machines which are functioning at a facility, the number of processing machines requiring repair, the number of containers located within the facility, the number of containers expected to be unloaded from delivery vehicles currently located at the delivery facility, the number of vehicles loaded and ready to leave the facility, the number of vehicles expected to arrive in a specific timeframe at the facility, and any other information which may be used to generate a KPI.

The resource availability database 135 contains information related to equipment available at one or more delivery facilities. The information in the resource availability database 135 may include the total number of resources, such as carriers, machine operators, supervisors, containers, employees, and the like, of the logistics network. In some embodiments, the resource availability database 135 can include the total number of resources of one or more delivery facilities, the number of resources scheduled to be present during a limited timeframe at one or more delivery facilities, the number of expected absent employees (e.g., the number of employees requesting time off) during a limited timeframe, the responsibilities of each resources, the additional responsibilities for which each employee is qualified (e.g., an operator of a mail sorting machine who is also qualified to drive a class 7 cargo van), and any other information about the resources of one or more delivery facilities collected and stored by the logistics network. The resource availability database 135 may be a single database of the entire logistics network. In some embodiments, there may be many resource availability databases 135, each of which contains information for one or more, or all of, the delivery facilities of the logistics network.

The equipment database 130 contains information about the various pieces of equipment (e.g., mail sorting machines, parcel scales, scanning devices, etc.) distributed throughout the delivery facilities of the logistics network. For example, the equipment database 130 may contain information about the current operational status of each piece of equipment, the number of each type of equipment, the last known location of each piece of equipment, information related to presumed missing equipment, parts required for regular maintenance of equipment, schedules for regular maintenance or inspection of equipment, and any other information relevant to the location and operation of all equipment throughout the logistics network. In some embodiments, more than one equipment database 130 may be used by the logistics network, with each equipment database 130 containing information for one or more connected delivery facilities. These multiple equipment databases may transmit their information to a single equipment database 130 for network-wide information access by system hub 140 or may each be individually connected to system hub 140.

The facility information database 145 contains information about the facilities of the logistics network. The information contained in the facility information database 145 may include the total square footage of a delivery facility, available square footage of a delivery facility, operational hours of a delivery facility, number of loading or unloading areas of a delivery facility, the location or number of cameras in a delivery facility, or any other information about the delivery facility maintained by the logistics network. The facility information database 145 may contain information for every delivery facility of the logistics network. In some embodiments, there may be multiple facility information databases 145 which each contain information for one or more delivery facilities. Where there are multiple facility information databases 145, they may transmit information to a single facility information database 145 for aggregation before information is sent to system hub 140. Optionally, any or all of the equipment database 130, resource availability database 135, key performance indicator database 110, and distribution network facility tracker 105 may be combined in a single system connected to system hub 140.

The system hub 140 has access to a user device alert system 120, and an interactive dashboard 150, which allow for users of system 100 to be alerted to issues detected by system hub 140, to be alerted to the implementation of a responsive action plan by system hub 140, or to give input on decision-making when human intervention is necessary for the implementation of a responsive action plan developed by system hub 140. The user device alert system 120 in some embodiments may delay the transmission of an alert to the user. The delay in sending the alert may be based on a time since the alert was generated, a confirmation of the issue causing generation of the alert (e.g., requesting from a system of a facility a confirmation of the cause, or determining based on a lack of response that the cause exists), or waiting for the generation of a second alert based on the same issue. The delay may allow the system to avoid generating false alerts where an issue was mistakenly reported (e.g., a user at a facility has input an incorrect value), or when the issue is corrected before generation of an alert would be useful to the user receiving the alert. The user device alert system 120 may, in some embodiments include the interactive dashboard 150 in a single system available to a user of a system 100. The user device alert system 120 and interactive dashboard 150 may be implemented as one or more of a web page accessible in a web browser, a mobile device application (e.g., an application available on the iOS App Store), a text message alert system, an automated calling system, or any other system capable of providing information to a user and optionally accepting user feedback to that information. The KPIs represent metrics that can be evaluated and used to predict or prevent gridlock, processing delays, errors, and the like. Each will be described in turn. The KPIs described herein are exemplary. The KPIs include “Processed Volume % Compared to Daily Average,” “Processed Volume % Compared to Current Capacity,” “Average entry time to 1st Auto Cycle Time,” “Delayed Package Inventory by Daily Average %,” “First Class Package Inbound Parcel Volume,” “Resource Availability %,” “Yard Cycle Time,” “Containers Closed Not Loaded,” “Scheduled Trips Not Departed,” and “% Square Footage Used.” In some embodiments, for example when different facility types (e.g., a network transfer centers (NTC), a surface trasnfer center (STC), etc.) are assigned KPIs by the system 100, additional or alternate KPIs may be included. Examples of additional KPIs include “Average Trailer Unload Cycle Time,” “Average Container Dwell Time,” “STC Exceptions,” “Estimated Containers in Building,” “Severely Delayed Packages in Transit,” and “Containers Older than 24 Hours.” A surface transport center can be a facility that distributes, consolidates, dispatches, and transfers all mail classes within the surface network.

The KPIs will be described in greater detail below.

Processed Volume % Compared to Daily Average is a KPI determined based on measuring the volume of items processed by, for example, a delivery facility compared to the delivery facility's capacity for processing items. Processing may include receiving items, counting, and sorting items, transferring items to machinery or locations of the facility involved in item processing, transferring items to a delivery vehicle, and the like. A delivery facility's current capacity may be determined as a theoretical operating capacity based on all available equipment and resources working at a highest practical efficiency, an operating capacity previously observed for the same facility at the same or similar resource levels at a similar or different time (e.g., the same holiday at least one previous year, each previous Monday for a previous number of weeks, etc.), an operating capacity of a similar facility observed for the same or a different day (e.g., a facility processing a similar volume of items, a facility with a similar number of resources available, etc.), and the like.

Processed Volume % Compared to Current Capacity is a KPI determined based on the number of items processed in a given timeframe (e.g., a day) to the average number of items processed in a different timeframe of the same length (e.g., the previous day, the same day in the previous week, etc.). In some embodiments, the same past four days (e.g., the past four Mondays) may be compared to the present day (e.g., the present Monday). Some embodiments may use different periods of time for comparison, as described above in relation to the delayed package inventory analyzer 245. The processed volume compared to daily average may be useful, for example, to determine that a facility is processing items for delivery at a lower rate than expected and remedial actions such as rerouting delivery or transport vehicles may then be taken as described below.

Average entry time to 1st Auto Cycle Time is a KPI determined based on the time elapsed from when an item is received by a facility to the time a first scan of the item occurs. The time an item is received by the facility may be determined, for example, based on the time a transport vehicle transporting the item to the facility arrived at the facility. The first scan of an item may, for example, by the time a resource of the facility first performs a scan of the item. The scan of the item may be automatic or manual. If the time between entry time and the first scan of an item at the facility occurs, this can indicate a delay or issue in the intake at a facility, or a slowdown in processing items at the facility such that the incoming items are delayed too long, for example, on a dock or in a staging area. The first auto cycle time may be useful to determine, for example, that more resources are needed at a facility to transfer items from transport or delivery vehicles to the facility.

Delayed Package Inventory by Daily Average % is a KPI determined based on the number of packages which are currently delayed at a facility compared to an expected number of delayed packages, such as the number of delayed packages for the same past four days (e.g., the number of delayed packages at the facility on the current Monday is compared to the number of delayed packages on the past four Mondays). In some embodiments, a percentage of currently delayed packages compared to the expected number of delayed packages, or other value, may be used. The number of same days may be more or less than four, and in some examples may be variable or fixed. Same days are used in order to ensure the comparison is valid. For example, the mail volume on a Monday may be significantly greater than the mail volume on a Wednesday when, for example, the facility does not process mail items on Sundays but continues to receive them. In this example, comparing the delayed packages on a Monday to the delayed packages on a Wednesday may not provide a useful value because the volume of mail being processed on Mondays differs from Wednesdays. Same days may, in some cases, refer to similar or like days. For example, the day following a weather event impacting mail delivery may be compared to previous days impacted in a similar way (e.g., the same number of facilities closed due to weather). For the purpose of determining the delayed package KPI, and other KPIs using a same day comparison, the KPI provides more useful insight into the distribution network when the comparison is made between days which may be considered the same or similar because expected item volumes, resource requirements and availability, and other factors impacting item delivery in a logistics network may generally follow daily, weekly, monthly, and seasonal (e.g., winter to winter comparison) patterns. Severely Delayed Packages in Transit is a KPI determined based on a number, percentage, or other value of packages severely delayed in transit. Whether a package is severely delayed may depend on a number of factors including, for example, a class of service associated with a package (e.g., Priority Mail, Overnight Air, etc.), a service expectation for the class of service (e.g., one-day delivery, two-day delivery, etc.), and the like. For example, a package sent First Class may be considered severely delayed if a scan of the package has not occurred in three days, but a package sent Priority may be considered severely delayed if a scan of the package has not occurred in four days. A scan may include a manual or automatic scan, for example, a manual scan taken by a handheld device associated with a driver, an automatic scan taken by a mail sorting machine, an automatic scan taken by a scanner recording items transferred to a truck, and the like. The severely delayed packages in transit may be useful to determine, for example, that more vehicles need to be routed to a facility, that items must be rerouted to other facilities, and the like.

First Class Package Inbound Parcel Volume is a KPI determined based on the number of packages with a service standard of First Class which have been scanned at the facility as being accepted but have not received a processing scan. In some embodiments, other service standards may be used for a similar KPI (e.g., a “Priority Package Inbound Parcel Volume” KPI may be calculated according to the same criteria but for packages of a service class of Priority). In some embodiments, some or all items with a service standard of First Class may be used to determine the KPI. A scan indicating a package has been accepted at the facility may be conducted manually, such as by a handheld computing device, or automatically, for example by a scanner mounted over a door of a receiving dock with a view of items passing through the door. A processing scan includes an automated scan by a processing machine, a manual scan conducted when an item is received at a processing area, a manual or automated scan conducted when an item is moved to a staging area for transport or delivery, and the like. In some embodiments, this KPI can be determined for items for service class or service standard, in addition to first class items.

Resource Availability % is a KPI determined based on the number of resources scheduled to be present at the facility compared to the actual number of resources present at the facility. The resources scheduled to be at the facility may be based on a resource schedule, resource database, time sheet information, resources scheduling tables, requested absences, injury reports, maintenance reports, transfer requests, and the like. The resources present at the facility may be determined based on information from a timecard system, a camera system configured to count the number of resources in a viewing area, information received from one or more automated scanners, and the like.

Yard Cycle Time is a KPI determined based on the length of time a vehicle of the logistics network remains in a specific location, for example the yard of a delivery facility. The length of time a vehicle remains in a location may be determined, for example, by a manual entry into a computing device, an automatic scan at the entry and exit points for vehicles, a camera observing the location where vehicles are stored for the delivery facility (e.g., a loading area), and the like. The yard cycle time may be useful to determine, for example, that more resources are needed at a facility to allow for faster loading or unloading of vehicles, that more resources are needed at a facility to facilitate the processing of items, and the like.

Containers Closed Not Loaded is a KPI determined based on a trend in the number of containers closed (i.e., prepared to be placed on a delivery or transport vehicle) but not yet loaded on a delivery vehicle. The trend may be determined, for example, based on an analysis of the number of containers closed but not loaded over the past four days. In some embodiments, the length of time may be longer than four days, shorter than four days, and the length of time may be fixed or variable (e.g., variable to account for days when containers are being closed but no delivery activity takes place and so the containers could not be loaded). The containers closed not loaded trend may be useful to determine, for example, that more delivery vehicles are needed at a facility, that mail needs to be rerouted to a facility with more available transport vehicles, and the like.

Scheduled Trips Not Departed is a KPI determined based on the number of trips scheduled to leave the delivery facility but which have not departed. The number of scheduled trips may be received by the scheduled trips not departed tracking database 215 from a separate database containing a planned or expected number of departing trips for a chosen timeframe. The number of trips departed may be received from a separate database, or, for example, from a scanner or camera at the exit point for delivery or transport vehicles. The scheduled trips not departed may be useful for determining, for example, that more transport or delivery vehicles are needed at the facility, that there is a backlog of delivery vehicles is occurring at a facility, that mail needs to be rerouted because it is not being loaded onto delivery vehicles, and the like.

% Square Footage Used is a KPI determined based on the percent of square footage of a delivery facility which is currently occupied. The percent square footage used may be determined by comparing the current available square footage to the total available square footage of the facility. The total available square footage of the facility may be determined based on a measurement, a floor plan of the facility, a structural information document of the facility (e.g., blueprints), or may be estimated based on automatic or manual measurements of the facility. The current available square footage of the facility may be determined based on, for example, a known or estimated size of all equipment and resources currently located in the facility, a known or estimated size of all containers currently located within the facility, one or more measurements made by a camera and used to calculated the size of objects in the facility, or a known or estimated size of any other object in the facility. The percent square footage used may be useful to determine, for example, whether the facility is able to physically store more items, whether a safe area is being maintained for the movement of resources, and the like.

Average Trailer Unload Cycle Time is a KPI determined based on the time recorded to have elapsed between when a trailer arrives at a facility and when the trailer has been unloaded. The time may be measured in seconds, minutes, hours, etc. The time when a trailer arrives may be determined based on an automated scan event, a manual recording of the time in a computing device, a camera system configured to track and record the arrival of trailers at a location of the facility, and the like. The unload time may be recorded based on an automated scan, a weight sensor of the trailer or the facility configured to determine when a trailer is empty, a manual input into a computing device, a camera system configured to recognize when all items have been removed from a trailer, and the like.

Average Container Dwell Time is a KPI determined based on the average time a container has remained in a facility, or at particular location in a facility, or in the same place without a scan or subsequent tracking or processing operation. In some embodiments, the average time is determined based on a comparison between the unload time and the load time associated with each container. The unload time may be determined based on an unload scan of the container, for example when the container is moved off of a transport or delivery vehicle or when the container is moved into the facility. The unload scan may be an automated scan performed by a scanning device located in an unloading area of the facility, a manual scan performed when the container is moved from a vehicle to a staging or unloading area in the facility, by a camera system configured to recognize and record the unloading of containers, and the like. The load time may be determined based on a load scan of the container, for example when the container is moved to a staging or loading area of the facility, or when the container is moved onto a transport or delivery vehicle. The load scan may be performed by a scanning device located in an unloading area of the facility, a manual scan performed when the container is moved from a vehicle to a staging or unloading area in the facility, by a camera system configured to recognize and record the unloading of containers, and the like.

STC Exceptions is a KPI determined based on a sum of the exceptions recorded during a time period for a surface transport center facility. The time period may be a fixed number of hours or days and may be a rolling time period, where at each update to the KPI the time period is advanced (e.g., when measurements are made hourly and the time period is 48 hours, the total exceptions for the 48 hours preceding the measurement are counted). In some embodiments, the time period may exclude certain hours or days (e.g., when the time period would include a holiday, or a time when the facility is non-operational). The STC Exception KPI may be updated a fixed interval, for example hourly, or a variable interval, for example hourly during operational hours and every four hours during non-operational hours. The total number of STC exceptions may be useful for determining when an STC is experiencing issues which may affect the delivery, receipt, or processing of items, and allow the system 100 to redirect items, vehicles, or equipment to minimize an impact on service of the logistics network.

Estimated Containers in Building is a KPI determined based on the estimated number of containers located in the facility. The number of containers in the facility may be estimated based on a comparison between scans of containers entering the facility and scans of containers which have left the building. The scans may be performed automatically, for example by scanners located in loading and unloading areas, manually, for example by an input into a computing device, by a camera system configured to determine when a container enters the facility and when a container leaves the facility (e.g., using computer vision), and the like. As with all KPIs based on scans, scan information from one or more systems may be combined.

Containers Older than 24 Hours is a KPI determined based on the number of containers in a facility that have received an unload scan 24 hours or more in the past and have not received a load scan. In some embodiments, containers which have not received a load scan within 72 hours may be excluded from the KPI determination. Excluding containers which have not received a load scan within 72 hours may allow the system to account for errors which occur and allow a container to be loaded onto a transport or delivery vehicle without being scanned. In some embodiments, all containers which have received an unload scan 24 hours or more previously and have not received a load scan may be counted. Additionally, some embodiments may count containers which received a load scan 12 hours or more previously, or use any other time frame. A load scan, as discussed previously, may occur automatically when a container is loaded onto a transport or delivery vehicle or moved to a loading or staging area, may occur manually such as by input into a computing device, or may be performed by a camera system using computer vision to determine and record when a container is loaded onto a transport or delivery vehicle, and the like. An unload scan, as discussed previously, may occur automatically when a container is unloaded from a transport or delivery vehicle or moved to an unloading or staging area, may occur manually such as by input into a computing device, or may be performed by a camera system using computer vision to determine and record when a container is loaded onto a transport or delivery vehicle, and the like. Measuring the number of containers which have remained at the facility for more than 24 hours may assist in determining when delivery plans need to be adjusted by the system 100 to account for a slowdown or other issue at a facility based on a high number of containers remaining at the facility for a longer than expected period of time.

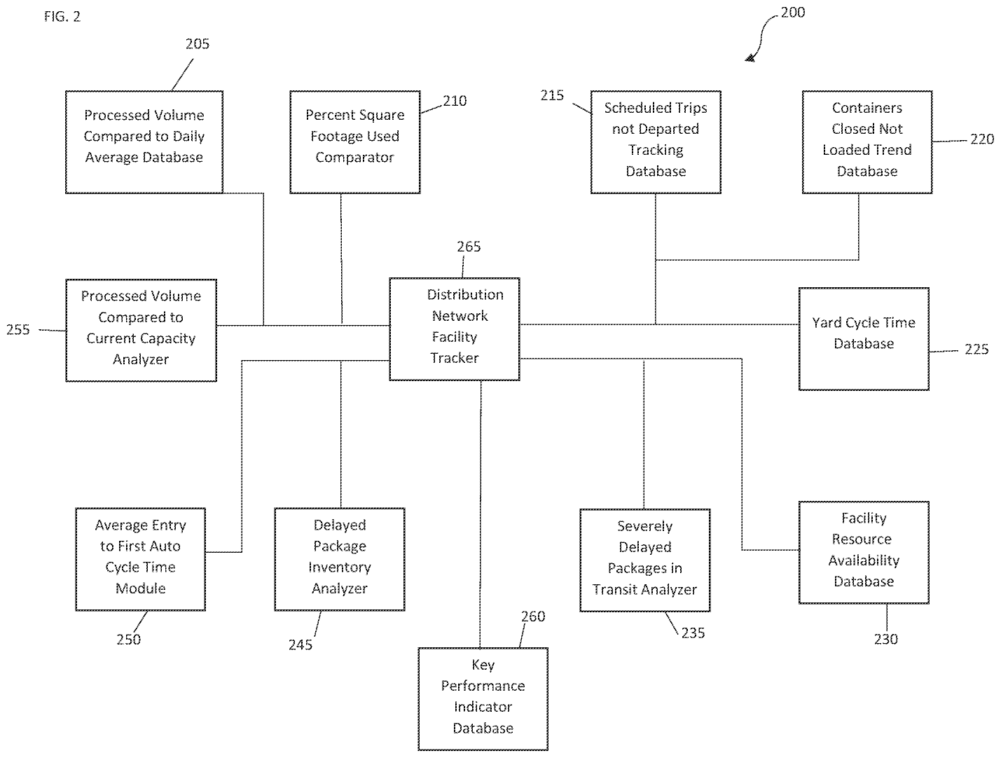

FIG. 2 shows an example system diagram of a configuration for a facility-level KPI generation system 200 for a delivery facility. The distribution network facility tracker 265 of a facility-level KPI generation system 200. The distribution network facility tracker 265 may be similar to those described elsewhere herein, for example the distribution network facility tracker 105. The distribution network facility tracker 265, in this example, is in communication with a processed volume compared to current capacity analyzer 255, an average entry to first auto cycle time module 250, a delayed package inventory analyzer 245, a severely delayed packages in transit analyzer 235, a yard cycle time database 225, a containers closed not loaded trend database 220, a scheduled trips not departed tracking database 215, a percent square footage used comparator 210, and a processed volume compared to daily average database 205.

The processed volume compared to current capacity analyzer 255 requests, receives, processes, and transmits information used to determine the “Processed Volume % Compared to Current Capacity” KPI, and stores information used to determine the KPI for one or more delivery facilities of the logistics network and one or more KPI values.

The first auto cycle time module 250 requests, receives, processes, and transmits information used to determine the “Average entry time to 1st Auto Cycle Time” KPI, and stores information used to determine the KPI for one or more delivery facilities of the logistics network and one or more KPI values.

The delayed package inventory analyzer 245 requests, receives, processes, and transmits information used to determine the “Delayed Package Inventory by Daily Average %” KPI, and stores information used to determine the KPI for one or more delivery facilities of the logistics network and one or more KPI values.

The severely delayed packages in transit analyzer 235 requests, receives, processes, and transmits information used to determine the “Severely Delayed Packages in Transit” KPI, and stores information used to determine the KPI for one or more delivery facilities of the logistics network and one or more KPI values

The yard cycle time database 225 requests, receives, processes, and transmits information used to determine the “Yard Cycle Time” KPI, and stores information used to determine the KPI for one or more delivery facilities of the logistics network and one or more KPI values

The containers closed not loaded trend database 220 requests, receives, processes, and transmits information used to determine the “Containers Closed not Loaded” KPI.

The scheduled trips not departed tracking database 215 requests, receives, processes, and transmits information used to determine the “Scheduled Trips Not Departed” KPI, and stores information used to determine the KPI for one or more delivery facilities of the logistics network and one or more KPI values.

The percent square footage used comparator 210 requests, receives, processes, and transmits information used to determine the “% Square Footage Used” KPI, and stores information used to determine the KPI for one or more delivery facilities of the logistics network and one or more KPI values.

The processed volume compared to daily average database 205 requests, receives, processes, and transmits information used to determine the “Processed Volume % Compared to Daily Average” KPI, and stores information used to determine the KPI for one or more delivery facilities of the logistics network and one or more KPI values.

Additional databases or analyzers may be included as part of the facility-level KPI generation system 200, where additional KPIs are of interest. For example, the “Average Trailer Unload Cycle Time,” “Average Container Dwell Time,” “STC Exceptions,” “Estimated Containers in Building,” and “Containers Older than 24 Hours” KPIs discussed above. Additional KPIs of interest may include a percent of processed mail volume over/under a like day, five-day mail volume trends, mail condition visualization trends, transport vehicles departed but not arrived, delayed transport dispatch, processed mail pieces converted to containers, containers organized by class or trip, total containers versus total available containers, time from mail arrival to unloading, power outages, machine downtime, maintenance risk indicators, mail cycle time by leg of transport, average container dwell time, camera outages, and problem pairs impacting downflows. Additional KPIs of interest, in some embodiments, may relate to mail volumes at origins and destinations, resource availability, mail transit, origin and destination space usage and availability, maintenance, and service.

The distribution network facility tracker 265 may further be in communication with a key performance indicator database 240 and a facility resource availability database 230. The key performance indicator database 240 and the facility resource availability database 230 may be maintained locally for a specific delivery facility, or may instead be the key performance indicator database 240 of the entire logistics network, which are in communication with. The key performance indicator database 240 and the resource availability database may be similar to those described elsewhere herein. The preceding elements of the facility-level KPI generation system 200 in communication with the distribution network facility tracker 265 are exemplary, and the distribution network facility tracker 105 may receive input from some or all of these elements, or any other additional system or database in connection with a KPI which the facility-level KPI generation system 200 is used to track.

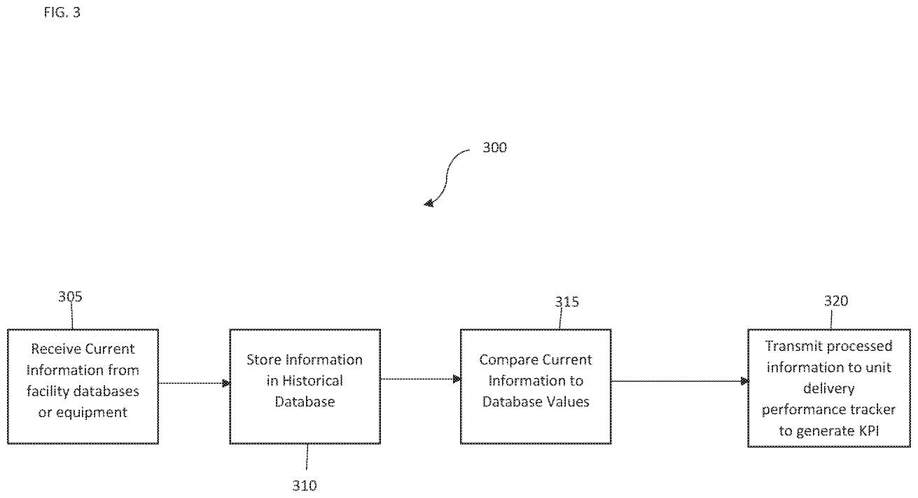

FIG. 3 is a process flow chart of one example of a process 300 for populating a generalized facility-level performance tracking database for tracking and reporting delivery facility performance information to the distribution network facility tracker 105. In some embodiments, the generalized facility-level performance tracking database may directly report information about an assessed KPI to a key performance indicator database 110 containing KPI information for one or more facilities.

At block 305, the generalized facility-level performance tracking database receives current information from the delivery facility's informational databases, the delivery facility's equipment, manual input of an employee of the logistics network, transportation equipment of the logistics network, or any other system of a delivery facility capable of reporting a status. Status input may be received, or determined, as an absolute value (e.g., the total number of containers closed not loaded) or as a percentage relative to an expected value (e.g., the percent of containers closed not loaded within the time window compared to the average number of containers closed not loaded within a comparable time window).

At block 310, the information received at block 305 may be transmitted to a database of a distribution network for storage. The database receiving information at block 310 may be maintained at the delivery facility level, the logistics network level, or in any other manner facilitating access to the database data for processing and generation of a KPI.

At block 315 a comparator system receives historical information from the database in addition to the current information transmitted at block 305 for comparison. The result of the comparison at block 315 is transmitted to a distribution network facility tracker 105 of the facility so that a KPI may be assessed for the compared data. In some embodiments, the generalized facility-level performance tracking database may transmit KPI information directly to the key performance indicator database 240 of the distribution network facility tracker 105. In some embodiments, the generalized facility-level performance tracking database may transmit KPI information to directly to system hub 140.

For the KPIs, and for other KPIs, depending on the range or the value of the KPI, an assessment can be made. The assessment may be a level of criticality of an issue, or can be a category for the facility or portion of the distribution network affected. Corrective actions can be taken based on the assessment. The assessment may also be provided to supervisors, operating personnel, and system components to take specific corrective actions. The assessments, as shown in the tables below, can have several levels of severity which indicate different levels of corrective actions or notifications. The levels can be “Contingency,” “Mitigation,” “Elevated,” “Normal,” and “Low.” Contingency can be the highest level, which demands the highest or most immediate corrective action, and Low can mean no action needs to be taken, with the other levels corresponding to intermediate states.

In some embodiments, each of the KPIs will be in a range for which a score or points may be assigned. The points can be assigned according to the range and assessment level. In some embodiments, the system 100 can use the KPIs, or some subset of the KPIs and their points to develop an overall score for a facility, piece of equipment, and the like. The overall score for a facility can cause certain corrective actions to be automatically initiated, which will be described in greater detail below. In some embodiments, when any one of the KPIs reaches a Mitigation or Contingency stage, corrective actions may be implemented, even when other KPIs are Elevated, Normal, or Low. Where the KPI is high, such as Mitigation or Contingency, or where the overall facility score is high, the system can automatically reroute vehicles, such as trucks or AGVs, in transit to other facilities or within a facility. When the KPI is low, such as Low or Normal, the system 100 can determine automatically that the facility has or will have future excess processing capacity and can reroute items to facilities with low scores on this KPI.

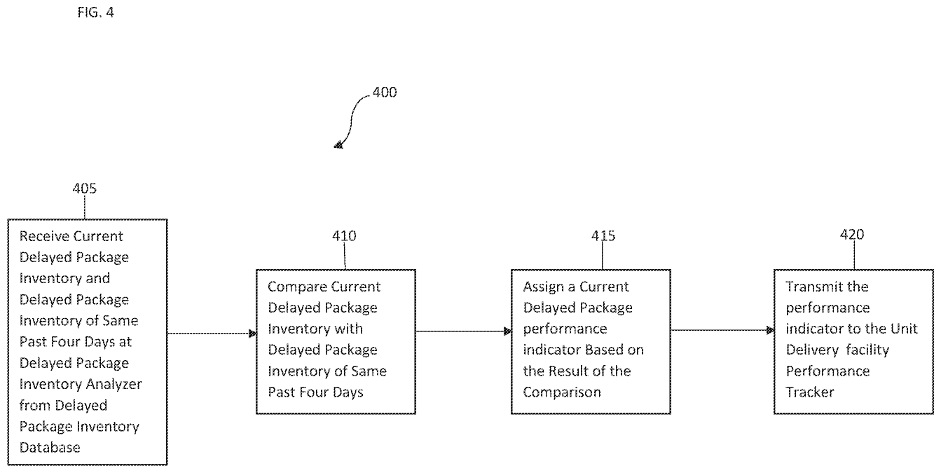

FIG. 4 is an example process flow diagram for a process 400 for populating a delayed package inventory analyzer 245. The delayed package inventory analyzer 245 assesses the number of delayed packages in inventory at a delivery facility and produces a KPI based on that assessment. At block 405, the delayed package inventory analyzer 245 receives information about the current delayed package inventory and the delayed package inventory of the same past four days (e.g., on a Monday receiving information about the past four Mondays) from a delayed package inventory database. While block 405 refers to receiving information about the same past four days, this is an example only and other timeframes may be selected. For example, one of the same past four days may be excluded due to a holiday, the same past ten days may be selected, or the same day following a holiday of the past five years may be selected (e.g., the day following Christmas of the past five years). An increase in the delayed package inventory indicates that there is a problem in a facility or in the network which is leading to increased delays in item or package movement or delivery. Examples of thresholds and performance indicator values (e.g., assessments) are shown below in Table 1. As seen in Table 1, a performance indicator value may have a number of points assigned. The points may be used by the key performance indicator database 110 or any other element of the system 100 to determine the overall status of a facility. At block 410, the current delayed package inventory is compared with the delayed package inventory of the same past four days. As noted above, the same past four days is an exemplary timeframe, and other timeframes may be used. The result of the comparison at block 410 is then used at block 415 to assign a performance indicator (e.g., a KPI), to the result of the comparison. This KPI is determined as a percent increase of delayed packages over a previous average. The performance indicator may be determined based on a fixed or dynamic threshold. The threshold may be determined based on an expected delayed package inventory, a historical delayed package inventory, a delayed package inventory of similar delivery facilities, a delayed package inventory of the logistics network, another value determined in relation to the current or past performance of one or more delivery facilities of the same or a different logistics network, or an arbitrary value.

TABLE 1

| Range | Assessment | Points Assigned |
|---|---|---|
| >500% increase | Contingency | 40 |
| 300-500% increase | Mitigation | 30 |
| 200-300% increase | Elevated | 20 |
| 100-200% increase | Normal | 10 |
| <100% increase | Low | 0 |

At block 420, the performance indicator assigned at block 415 is transmitted to the distribution network facility tracker 105. Optionally, the processed volume compared to daily average database 205 may transmit directly to the key performance indicator database 240 of the distribution network facility tracker 105 or the distribution network facility tracker 265. In some embodiments, the daily average database 205 may transmit the performance indicator to system hub 140.

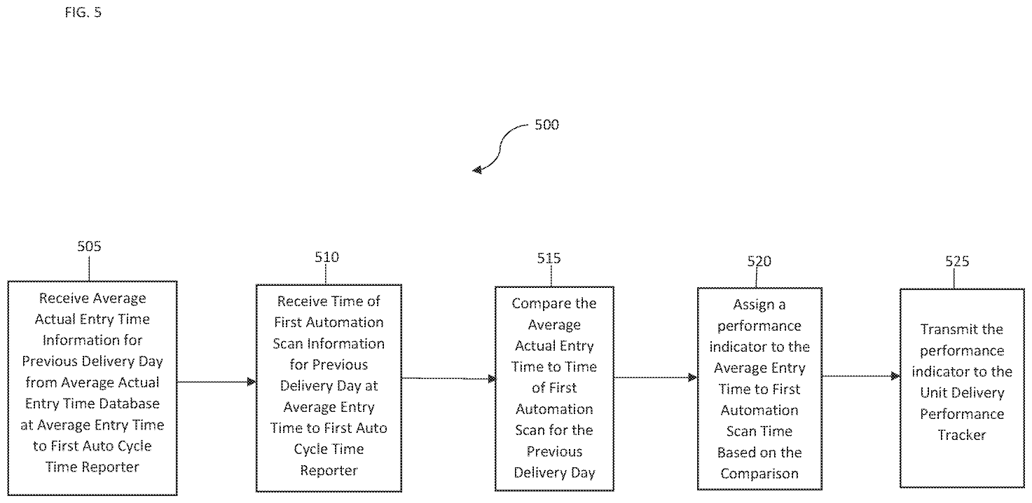

FIG. 5 is an example flow diagram for a process 500 for populating a first auto cycle time module 250. At block 505 the first auto cycle time module 250 receives the average entry time information of items received for delivery for the previous delivery day. At block 510, the average entry to first auto cycle time module 250 receives the time of the first automation scans for items received for delivery for the previous delivery day. At block 515, the average entry to first auto cycle time module 250 compares the average actual entry times to the first automation scan times for the previous delivery day. At block 520, the average entry to first auto cycle time module 250 assigns a performance indicator (e.g., a KPI) to the result of the comparison at block 515. Examples of threshold values and performance indicators (e.g., assessments) may be seen below in Table 2. The range for this KPI can be measured in hours. While the present example flow diagram refers to the previous delivery day throughout the process, the average entry to first auto cycle time module 250 may compare information for any day or any portion of a day (e.g., from 0000 h to 1200 h of the current day) to assign a performance indicator. At block 525, the average entry to first auto cycle time module 250 transmits the assigned performance indicator to a distribution network facility tracker 105. Optionally, the processed volume compared to daily average database 205 may transmit directly to the key performance indicator database 240 of the distribution network facility tracker 105.

When the assessment of this KPI is Elevated, alerts can be provided. When the assessment is Mitigation, the system 100 can automatically change a sorting plan, reroute items within item processing equipment, speed up processing, etc. when the assessment is Contingency, similar corrective actions maybe taken immediately, automated guided vehicles (AGV) can be summoned either within the facility or external AGVs can be summoned to move items out of the facility to make room for incoming items, or to take the unprocessed incoming items to another facility where there is more capacity.

TABLE 2

| Range | Assessment | Points Assigned |
|---|---|---|
| >72 | Contingency | 40 |
| 49-72 | Mitigation | 30 |
| 25-48 | Elevated | 20 |
| 13-24 | Normal | 10 |
| 0-12 | Low | 0 |

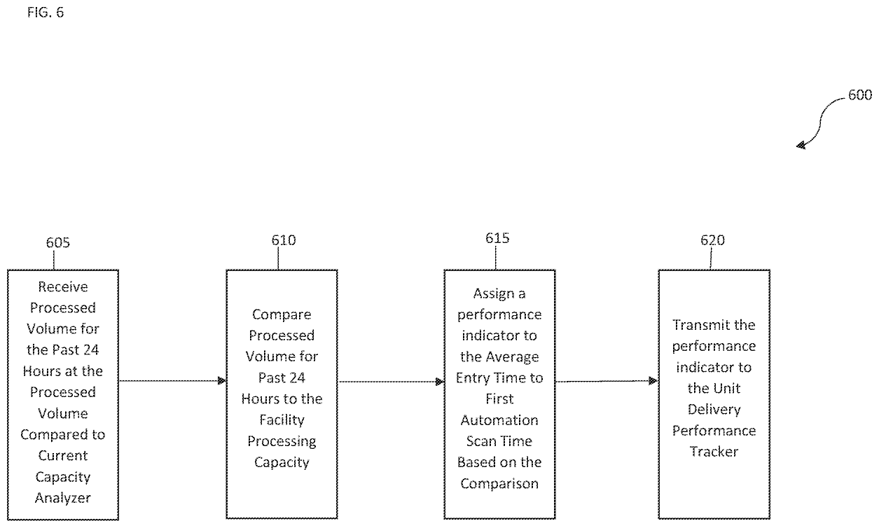

FIG. 6 is an example flow diagram for a process 600 for populating the processed volume compared to current capacity analyzer 255. At block 605, the processed volume compared to current capacity analyzer 255 receives information about the volume of parcels processed by the delivery facility in the past twenty-four hours. In this example, information is received indicating processing volume of the delivery facility from a first database, and capacity figures are provided by a second database. The first and second database may be the same database, different tables within the same database, or the like. The timeframe for the processed volume information received does not need to be twenty-four hours, but could be any length of time on any day (e.g., a twelve-hour timeframe during the previous delivery day). At block 610, the processed volume compared to current capacity analyzer 255 compares the processed volume of parcels for the past 24 hours to the delivery facility's total processing capacity. Processing capacity may be fixed or variable. Variable processing capacity could be based on any factor relevant to a delivery facility's capacity to process mail for example, a delivery facility's number of available resources, number of available equipment, a square footage of available floorspace for processing, a weather event, an availability of parcel delivery vehicles, a processing efficiency of another delivery facility either sending to or receiving parcels from the delivery facility for which the comparison is being performed, or any other factor which may affect the delivery facility's capacity to process parcels at any time. This KPI is a percentage of the capacity being used to process items. As this percentage increases, a facility is becoming busier, which can indicate that a trend, if left unchecked, could result in a run plan at a facility that requires more capacity than a facility has. Where the KPI is high, such as Mitigation or Contingency, the system can automatically reroute vehicles, such as trucks or AGVs, in transit to other facilities or within a facility. When the KPI is low, such as Low or Normal, the system 100 can determine automatically that the facility has or will have future excess processing capacity and can reroute items to facilities with low scores on this KPI.

At block 615, a performance indicator value is assigned to the result of the comparison of block 610. The performance indicator may be determined dynamically, may be based on predetermined values, a relative comparison of delivery facilities for the same day, a relative comparison of a delivery facility with itself on another day, or a relative comparison of a delivery facility with a comparable delivery facility with a similar layout, similar equipment, or similar personnel available. An example of the performance indicator value and thresholds used to determine the performance indicator value may be seen below in Table 3. Additionally, a performance indicator value may be associated with a number of points, and the points may be used by the key performance indicator database 110 or any element of the system 100 to determine the current status of a facility.

TABLE 3

| Range | Assessment | Points Assigned |
|---|---|---|
| >70% | Contingency | 40 |
| >50%-70% | Mitigation | 30 |
| >30%-50% | Elevated | 20 |
| >10%-30% | Normal | 10 |
| 0-10% | Low | 0 |

At block 620, the processed volume compared to current capacity analyzer 255 transmits the performance indicator to the distribution network facility tracker 105. Optionally, the processed volume compared to daily average database 205 may transmit directly to the key performance indicator database 240 of the distribution network facility tracker 105.

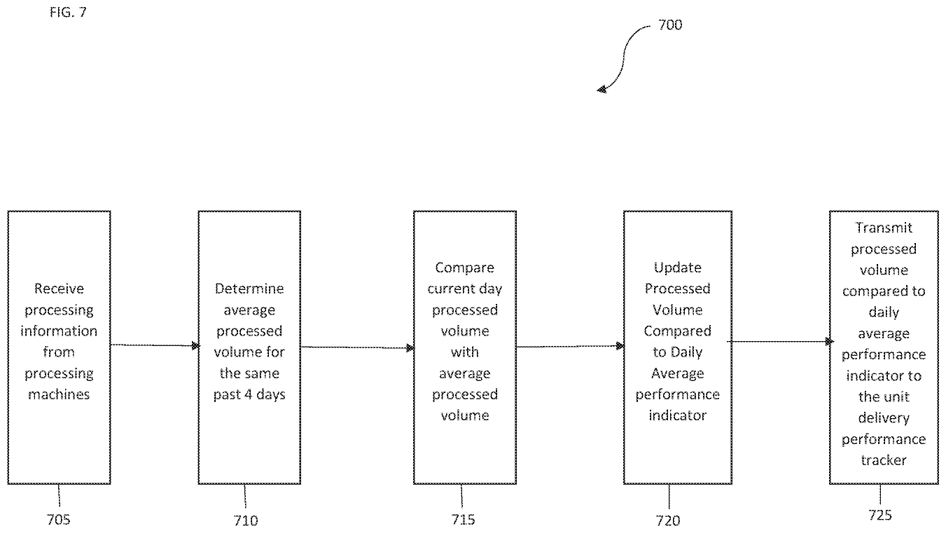

FIG. 7 is an example flow diagram for a process 700 for populating a processed volume compared to daily average database 205. At block 705, the processed volume compared to daily average database 205 receives processing information from the processing machines of the delivery facility. In some embodiments, the processing information may be received by a database stored in a non-transitory memory of a computing device, which then transmits the processing information to the daily average database 205. Processing information may be automatically sent by the processing machines, in some embodiments a machine operator may at any time upload processing information from one or more processing machines. The transmission of processing information may be automatic, based on a threshold time or mail volume, based on a fixed or dynamic time, or in response to any other reason which may be determined as relevant in transmitting processing volumes. In some embodiments, the transmission may be initiated manually on one or more processing machines. Further, processing information may be transmitted from individual machines directly to a database, the database may be the same as the processed volume compared to daily average database 205 or may be another database which collects information from some or all processing machines before forwarding the information to the processed volume compared to daily average database 205.

At block 710, the average processed volume for the same past four days (e.g., the past four Mondays) is determined. While this example flow diagram refers to the same past four days, alternatives may be used. For example, the same past three days (e.g., the past three Mondays), the same day one year previously (e.g., the first Monday of January), the same day preceding a holiday of at least one previous year (e.g., the day before Thanksgiving of the past three years), or any other date range which may provide a useful comparison as described above in relation to the delayed package inventory analyzer 245 in FIG. 2. The Ranges shown for this KPI in Table 4 below indicate a percent increase This KPI is a percentage of the average capacity being used to process items. As this percentage increases, it indicates that a facility is becoming busier. This increasing busyness trend can indicate that a trend, if left unchecked, could result in a run plan at a facility that requires more capacity than a facility has. Where the KPI is high, such as Mitigation or Contingency, the system can automatically reroute vehicles, such as trucks or AGVs, in transit to other facilities or within a facility. When this KPI is low, such as Low or Normal, the system 100 can determine automatically that the facility has or will have future excess processing capacity, and can reroute items to facilities with low scores on this KPI.

At block 715, a comparison is made between the current day's processed volume, based on the information received at block 705, and the average processed volume determined at block 710. While the current day's volume is used in this example, the timeframe for comparison may be more or less than one day (e.g., for the past twelve hours). At block 720 a performance indicator is updated reflecting the result of the comparison at block 715. This performance indicator may be a static threshold, or dynamically determined based on one or more factors relevant to the processing capacity of the delivery facility for the timeframe used in block 715. Further, the performance indicator may be specific to an individual delivery facility or determined relative to some or all other delivery facilities in the logistics network. Additionally, the performance indicator may be based in part on an expected or an actual performance of the delivery facility. An example of the values used to determine a performance indicator (e.g., an assessment) is shown below in Table 4. Additionally, a performance indicator value may be associated with a number of points, and the points may be used by the key performance indicator database 110 or any element of the system 100 to determine the current status of a facility.

TABLE 4

| Range | Assessment | Points Assigned |
|---|---|---|
| >20%+ | Contingency | 40 |
| >15-20% | Mitigation | 30 |
| >10-15% | Elevated | 20 |
| >0-10% | Normal | 10 |
| 0% or less | Low | 0 |

At block 725, the processed volume compared to daily average database 205 transmits the performance indicator to the distribution network facility tracker 105. Optionally, the processed volume compared to daily average database 205 may transmit directly to the key performance indicator database 240 of the distribution network facility tracker 105.

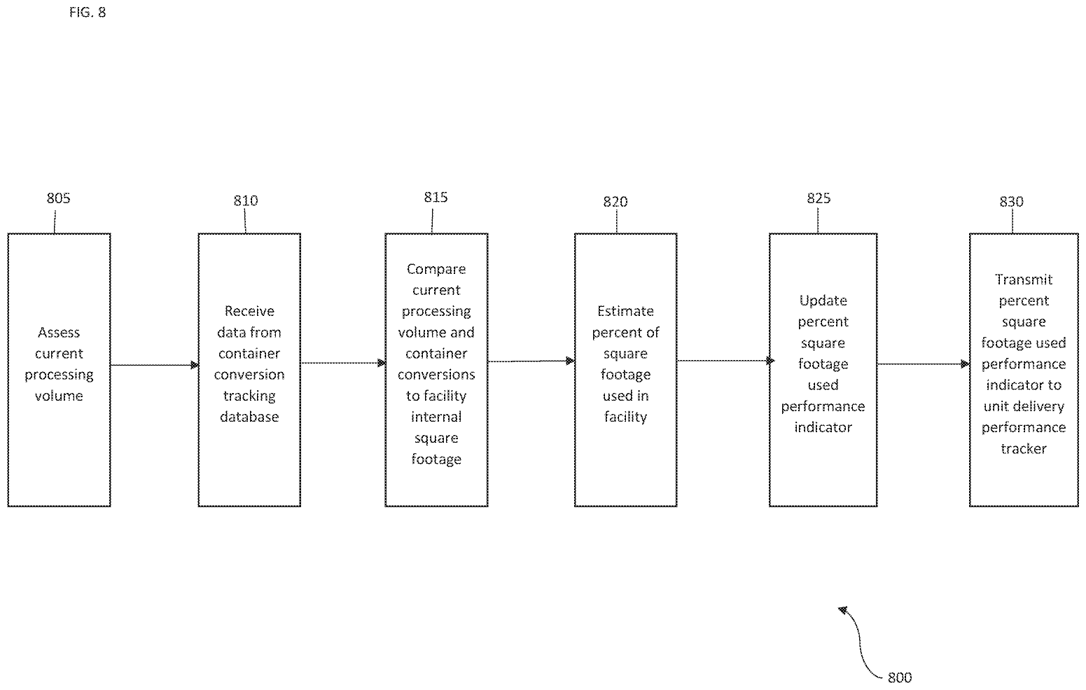

FIG. 8 is an example process flow diagram for a process 800 for populating an example percent square footage used comparator 210. At block 805 the percent square footage used comparator 210 can receive information from sensors, cameras, floorplan maps, and the like to determine how many items are in a given area, and what the footprint of those items is. The footprints of the items can be compared to the total square footage available for items to determine a percent for this KPI. In some embodiments, the system 100 can determine that generally 14% of a facility's square footage not occupied by fixtures such as processing equipment is space available for item staging, storage or utilization, for aisles, vehicles such as AGVs, and the like.

At block 810, data is received at the percent square footage used comparator 210 from a container conversion tracking database. Block 810 and block 805 may occur substantially simultaneously or in the opposite order. The container conversion tracking database may be updated in various ways to measure the number of containers available, awaiting processing, and awaiting loading onto a delivery vehicle, or in any other state when located at or around the delivery facility. Data for the container conversion tracking database may be updated manually by one or more employees of the delivery facility. In some embodiments, the container conversion tracking database may be updated automatically. For example, by equipment used to scan parcels or containers, by processing equipment, by a camera system capable of recognizing containers and identifying the container size and/or type, or by any other automated process capable of measuring the number of containers at a delivery facility and determining the stage of such containers in processing. The container conversion tracking database may further store information related to the square footage filled by a type of container.

At block 815, the percent square footage used comparator 210 compares the current processing volume and container conversions to the delivery facility internal square footage. The current processing volume may consider the volume occupied by parcels at the delivery facility, the volume occupied by bins required to hold the parcels awaiting processing or awaiting loading onto delivery facilities. The results of block 815 are compared to a known or estimated square footage of the delivery facility at block 820 to generate an estimate of the percent of square footage occupied in the delivery facility. The estimate at block 820 may take into account various known factors affecting square footage occupied in the delivery facility. For example, the square footage occupied by fixed machinery, the square footage occupied by mobile machinery, the square footage occupied by lanes allowing the movement of humans or machinery, the square footage available but not usable in the delivery facility, or any other information relevant to the occupied or unoccupied square footage of the delivery facility.

At block 825, a performance indicator for the percent of square footage used is updated. The performance indicator may be a fixed or dynamic value representing a preferred or expected percentage of the square footage of the delivery facility occupied or unoccupied. An example set of threshold values used to determine a performance indicator (e.g., an assessment) is shown below in Table 5. Additionally, a performance indicator value may be associated with a number of points, and the points may be used by the key performance indicator database 110 or any element of the system 100 to determine the current status of a facility. At block 830, the performance indicator is transmitted to the percent square footage used comparator 210 transmits the performance indicator to the distribution network facility tracker 105. Optionally, the percent square footage used comparator 210 may transmit directly to the key performance indicator database 240 of the distribution network facility tracker 105.

TABLE 5

| Range | Assessment | Points Assigned |
|---|---|---|
| >20%+ | Contingency | 40 |
| >15-20% | Mitigation | 30 |
| >10-15% | Elevated | 20 |
| >0-10% | Normal | 10 |
| 0% or less | Low | 0 |

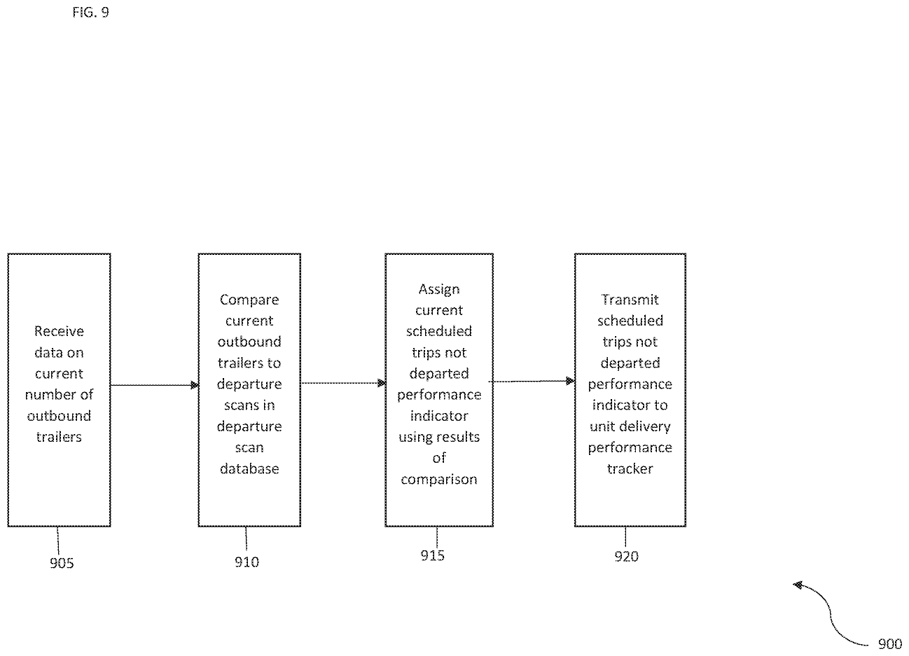

FIG. 9 is an example process flow diagram for a process 900 for populating a scheduled trips not departed tracking database 215. At block 905, the scheduled trips not departed tracking database 215 receives data on current outbound trailer statuses. The current outbound trailer status may be entered manually. In some embodiments, the current outbound trailer status may be tracked automatically. For example, the current outbound trailer status may be based on location tracking of trailers (e.g., GPS, Bluetooth, radio signal, etc.), a schedule of trailers expected to depart, or any other automated method of tracking scheduled outbound trailers. In this example, trailer status is determined from a surface visibility (SV) system where information is refreshed hourly for all trips scheduled to depart in the last 24 hours, but not within the past two hours, for which there has been no departure scan.

At block 910, the information on outbound trailers received at block 905 is compared to a number of departure scans, optionally stored in a departure scan database or in any other data structure accessible to the scheduled trips not departed tracking database 215. Departure scans may be manually entered or tracked automatically. In some implementations, the departure scan information of a specific period of time may be used (e.g., all scans for the past 24 hours but not the past two hours) for the comparison.

At block 915, a performance indicator for the current scheduled trips not departed is assigned based on the result of the comparison in block 910. The performance indicator may be a fixed or dynamic value representing a preferred or expected level of scheduled trips not departed. The level may be based on a number of trips scheduled not departed, a percentage of trips schedule not departed, and may be determined in relation to previous numbers at an individual delivery facility, previous numbers at similar delivery facilities to the delivery facility being evaluated, previous or expected numbers across the logistics network, or in any other way that is useful for determining performance of a delivery facility. An example of a set of values used to determine a performance indicator value (e.g., an assessment) for a facility is shown below in Table 6. Additionally, a performance indicator value may be associated with a number of points, and the points may be used by the key performance indicator database 110 or any element of the system 100 to determine the current status of a facility.

TABLE 6

| Range | Assessment | Points Assigned |
|---|---|---|
| Greater than 6 trips | Contingency | 40 |

| | | | |
|---|---|---|---|
| 5-6 | trips | Mitigation | 30 |
| 4 | trips | Elevated | 20 |
| 3 | trips | Normal | 10 |
| <3 | trips | Low | 0 |

At block 920, the scheduled trips not departed tracking database 215 transmits the performance indicator assigned at block 915 to the distribution network facility tracker 105. Optionally, the scheduled trips not departed tracking database 215 may transmit directly to the key performance indicator database 240 of the distribution network facility tracker 105.

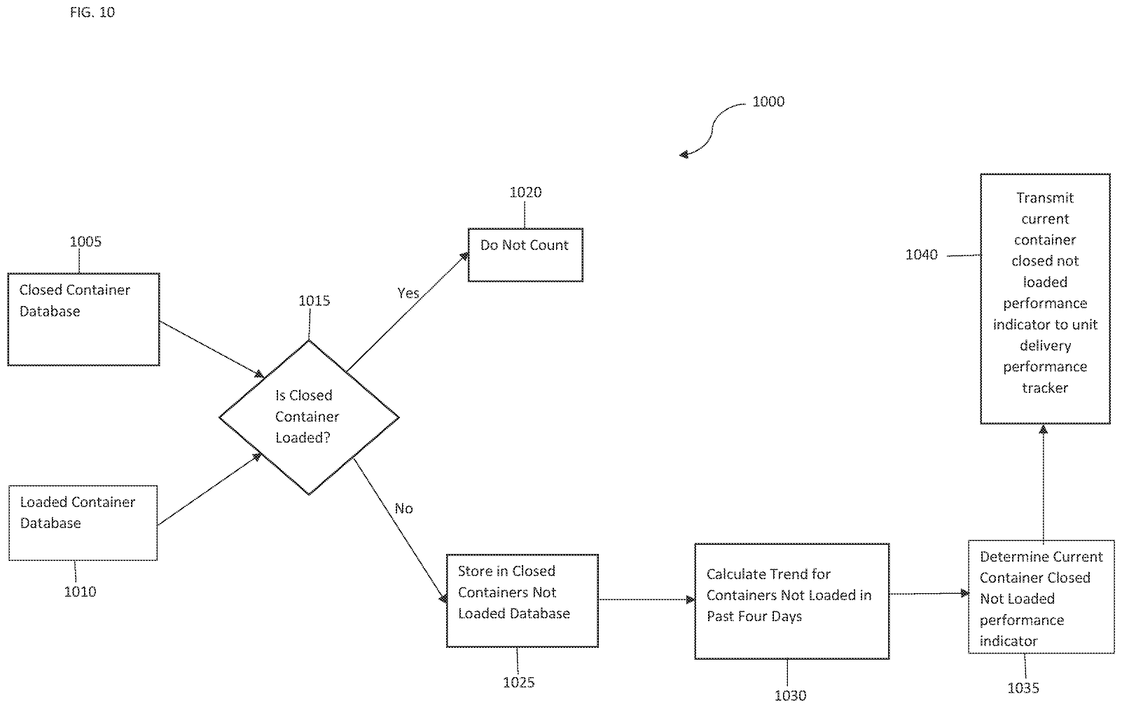

FIG. 10 is an example process flow diagram for a process 1000 for populating the containers closed not loaded trend database 220. At block 1005 the containers closed not loaded trend database 220 receives information about the closed containers of the delivery facility. At block 1010 the containers closed not loaded trend database 220 receives information about the containers loaded onto transport vehicles. Block 1005 and block 1010 can occur in any order, or simultaneously. In some embodiments, the loaded container database of block 1010 and the closed container database of block 1005 may be one database tracking all containers of the delivery facility, or may be tables of the containers closed not loaded trend database 220. Further, information as to the status of a container may be updated manually or automatically, for example by a scanning device.

At block 1015, a determination is made as to whether each closed container has been loaded. If a container is closed and loaded onto a delivery vehicle, then the process moves to block 1020 and the container is not counted. In some embodiments, if a container is closed and not loaded then to process moves to block 1025 and the container is counted as closed and not loaded in the containers closed not loaded trend database 220. The container information may include an identifier of each container closed not loaded, information about the contents of the container, information about the location of the container, and any other information which may be useful in determining the status of the container.

At block 1030, a trend is calculated for the number of containers closed and not loaded in the past four days. While this example uses a timeframe of four days, alternative timeframes may be used including counting more or fewer days, portions of one or more days (e.g., 0000 h to 1200 h of the previous two days), or excluding days during which processing does not occur (e.g., four of the past five days between December 21 and 26, excluding December 25). The trend calculated at block 1030 may be increasing, decreasing, or flat. At block 1035, a performance indicator for containers closed not loaded is assigned based on the trend calculated at block 1030. This performance indicator may be a static or dynamic value. The performance indicator may be determined based on a previous trend of the same delivery facility, a previous trend of a similar delivery facility, an expected trend based on the requirements of the logistics network, or any other metric useful in assessing the trend of containers closed not loaded at a delivery facility. An example of a set of values used to assign the performance indicator value is shown below in Table 7. Additionally, a performance indicator value may be associated with a number of points, and the points may be used by the key performance indicator database 110 or any element of the system 100 to determine the current status of a facility. A positive number for the trend means an upward trend, or more containers being closed and not loaded onto a vehicle or other type of transportation. A negative number for the trend means a downward trend, or fewer containers are closed and not loaded.

TABLE 7

| Range | Assessment | Points Assigned |
|---|---|---|
| Trend increasing at 7+ | Contingency | 40 |
| Trend increasing at 5-7 | Mitigation | 30 |
| Trend increasing at 3-4 | Elevated | 20 |
| Trend increasing at 1-2 | Normal | 10 |
| Trend increasing at less | Low | 0 |
| than 1 | | |

At block 1040, the containers closed not loaded trend database 220 transmits the current containers closed not loaded performance indicator determined at block 1035 to the distribution network facility tracker 105. Optionally, the containers closed not loaded trend database 220 may transmit the performance indicator directly to the key performance indicator database 240 of the distribution network facility tracker 105.

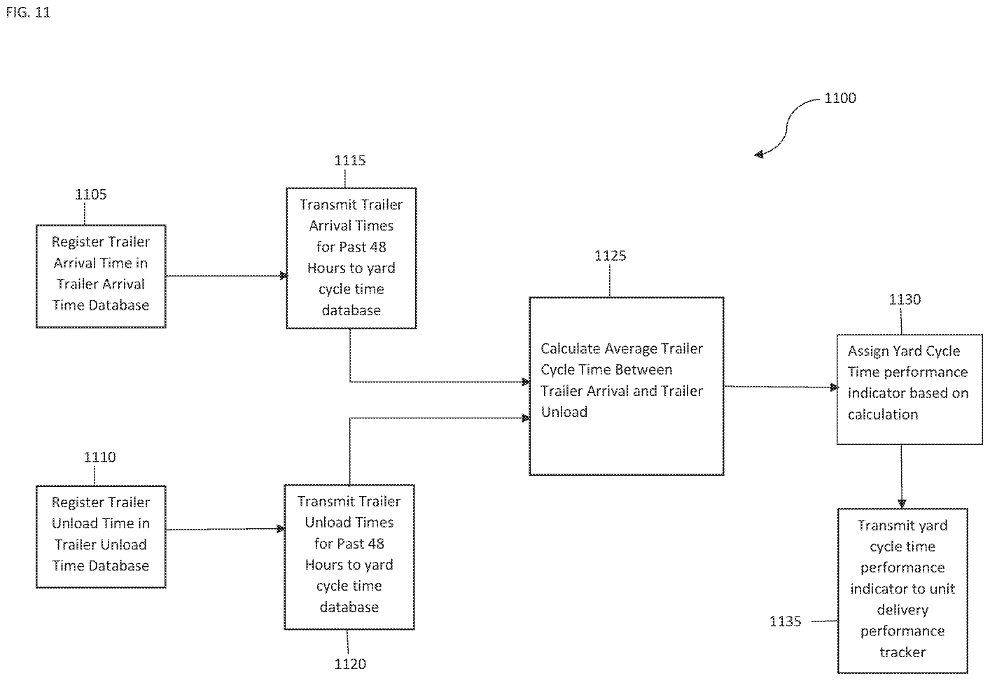

FIG. 11 is an example process flow diagram for a process 1100 for populating the yard cycle time database 225. At block 1105, a trailer arrival is registered in a trailer arrival time database. This registration may be performed automatically, for example by a camera system or automated scanner, or manually. At block 1110, a trailer unload time is stored in a trailer unload time database. The trailer unload time may be registered automatically, for example by a scanning machine, or manually. While a trailer arrival time database and a trailer unload time database are described separately here, they may be portions of a single database such as the yard cycle time database 225 or stored in any other data storage system accessible to the yard cycle time database 225. Additionally, while blocks 1105 and 1110 are shown to occur in parallel in FIG. 11, they may occur at different times, simultaneously, or in a different order (e.g., block 1115 may lead to block 1110), based on when information is collected, stored, and transmitted.

At block 1115, the trailer arrival times for the past 48 hours are transmitted to the yard cycle time database 225. At block 1120, the trailer unload times for the past 48 hours to the yard cycle time database 225. While a timeframe of 48 hours is used for this example, other timeframes may also be used. For example, trailer arrival times for the past three days, trailer arrival times between 0000h and 1200h, trailer arrival times for the past 72 hours but excluding a 12-hour period where the delivery facility was closed, or any other timeframe.

At block 1125, the average trailer cycle time between trailer arrival and trailer unload is calculated based on the information received at block 1115 and 1120. In some embodiments, a median, mode, or other measure of cycle time between trailer arrival and trailer unload may be used. At block 1130, a yard cycle time performance indicator is assigned based on the results of the calculation in block 1125. The performance indicator may be assigned relative to a fixed or dynamic value. The value may be determined based on past actual or expected performance of the delivery facility, other similar delivery facilities, past actual or expected performance of the logistics network, or any other metric useful in assessing the performance of a delivery facility's time between trailer arrival and trailer unload. An example of a set of values used to determine the performance indicator value (e.g., the assessment) is shown below in Table 8. Additionally, a performance indicator value may be associated with a number of points, and the points may be used by the key performance indicator database 110 or any element of the system 100 to determine the current status of a facility.

TABLE 8

| Range (in Minutes) | Assessment | Points Assigned |
|---|---|---|
| >53 | Contingency | 40 |
| >38-53 | Mitigation | 30 |
| >23-38 | Elevated | 20 |
| >8-23 | Normal | 10 |
| 8 or fewer | Low | 0 |

At block 1135, the performance indicator assigned at block 1130 is transmitted from the yard cycle time database 225 to the distribution network facility tracker 105. Optionally, the yard cycle time database 225 may transmit the performance indicator directly to the key performance indicator database 240 of the distribution network facility tracker 105.

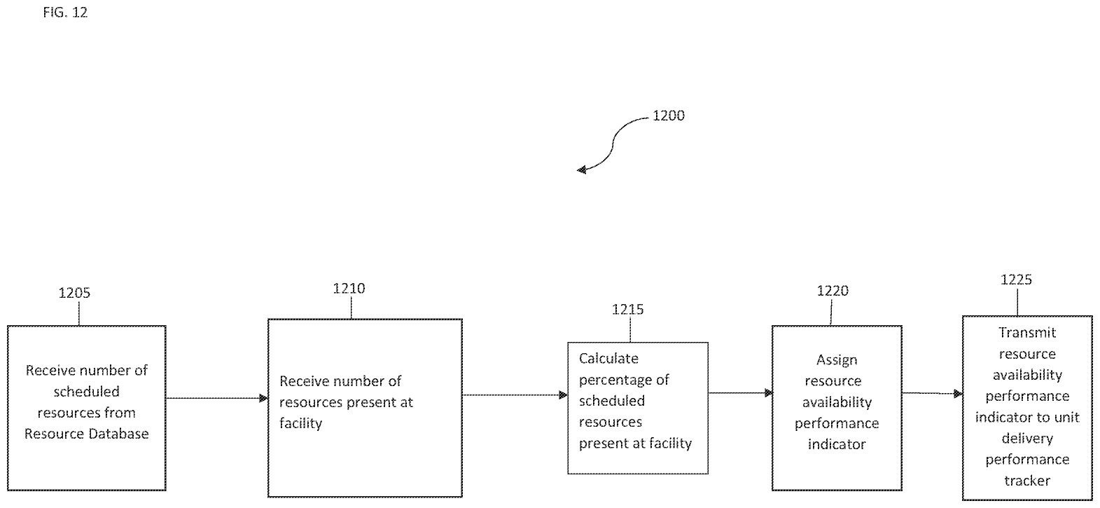

FIG. 12 is an example process flow diagram for a process 1200 for populating a resource availability database (e.g., facility resource availability database 230 or resource availability database 135). At block 1205, the resource availability database receives information related to the number of resources available or scheduled to work on a given day from a resource availability database 135 of the logistics network. In some embodiments, the resource information may be received from a facility resource availability database 230 of a distribution network facility tracker 105, or a resource availability database maintained separately from the distribution network facility tracker 105 for a delivery facility (e.g., resource availability database 135).

At block 1210, the number of scheduled resources received in block 1205 is compared to the number of resources present at a delivery facility. The number of resources present at a delivery facility may be determined in many ways. For example, by a time clock system used for payment of employees, by an automated camera system, by an internal tracking system of the delivery facility, by a manual reporting, or by any other method capable of counting the number of employees present at a delivery facility.

At block 1215, a percentage of resources present at a facility is calculated based on the information received at block 1205 and block 1210. While block 1215 describes calculating a percentage, other useful values may be calculated instead. For example, a number of resources less than expected (e.g., 10 less resources present compared to scheduled), or a percentage of resources scheduled but not present.

At block 1220, a performance indicator is assigned based on the results of the calculation in block 1215. The performance indicator may be assigned based on a fixed or dynamic threshold. The value of a threshold may be determined based on expected or actual percentages of scheduled resources present at a facility, historical percentages of employees scheduled and present at a facility, numbers of resources scheduled and present at similar facilities on the same or different days, or an expectation for the logistics network as a whole. An example of a set of values used to determine the performance indicator value (e.g., the assessment), including threshold values, is shown below in Table 9. Additionally, a performance indicator value may be associated with a number of points, and the points may be used by the key performance indicator database 110 or any element of the system 100 to determine the current status of a facility. Where the Assessment of this KPI is low, the system 100 can reroute AGVs and other vehicles to other facilities with higher resource availability and can request additional resources be assigned to a facility. In some embodiments the system 100 can change a run or sort plan to utilize equipment which requires fewer resources or take other corrective actions.

TABLE 9

| Range | Assessment | Points Assigned |
|---|---|---|
| Less than 55% | Contingency | 40 |
| 55-<65% | Mitigation | 30 |
| 65-<75% | Elevated | 20 |
| 75-<85% | Normal | 10 |
| >85% | Low | 0 |

At block 1225, a resources availability performance indicator is transmitted from the resources availability database to the distribution network facility tracker 105. Optionally, the resources availability database may transmit the performance indicator directly to the key performance indicator database 240 of the distribution network facility tracker 105, or to the facility resource availability database 230 of the distribution network facility tracker 105, or to the resource availability database 135 of the logistics network.

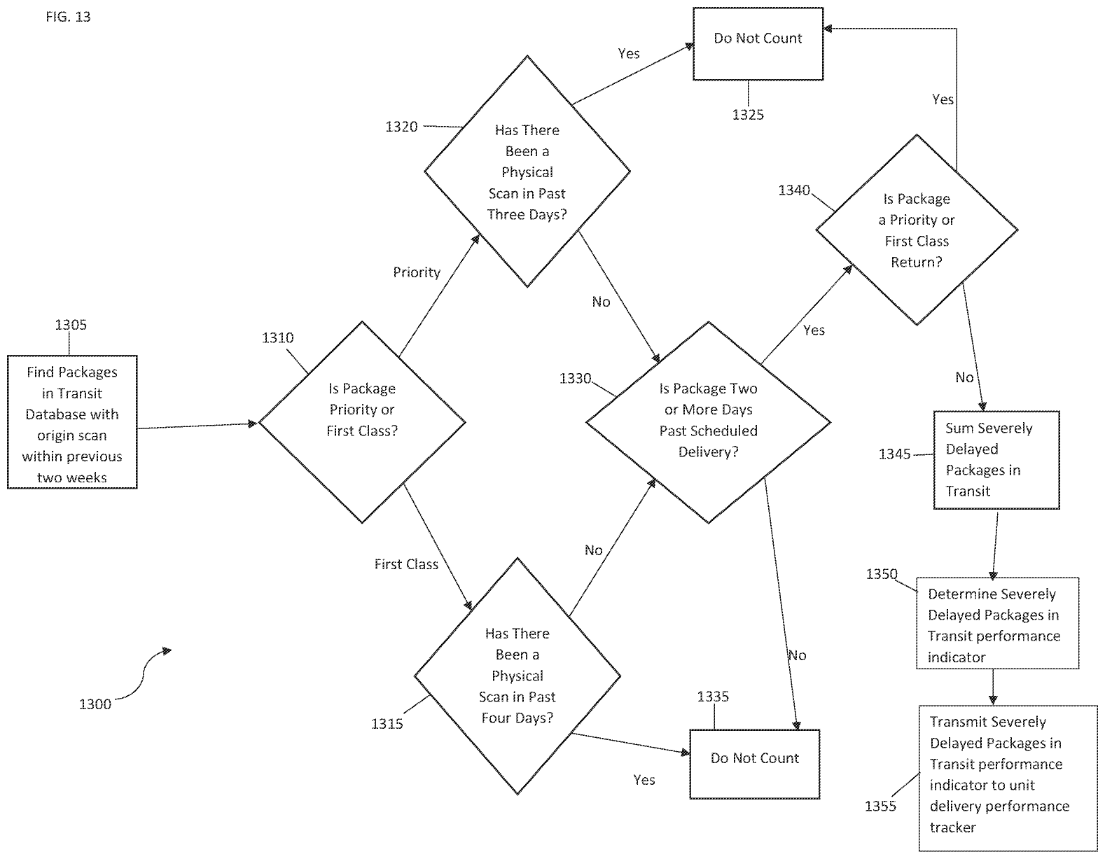

FIG. 13 is an example process flow diagram for a process 1300 for populating the severely delayed packages in transit analyzer 235. At block 1305, packages in a transit database with an origin scan within the past two weeks are identified. The transit database may store information about a package's type, size, weight, service standard, origin, destination, and any other information relevant to the transport of a parcel. While the past two weeks is the timeframe described herein, other timeframes may be used (e.g., the past 15 days, the past 10 days on which parcel pickup occurred, the past 5 days excluding a holiday, etc.).

At decision state 1310, a determination is made as to whether a package identified at block 1305 was sent as either Priority Mail or First-Class Mail. While this example process uses Priority and First-Class service standards, other service standards may be considered as part of the severely delayed packages in transit analyzer 235 (e.g., Priority Mail Express, USPS marketing mail, periodicals, etc.).

When a package is determined to be Priority Mail at block 1310, the severely delayed packages in transit analyzer 235 moves to block 1320. At block 1320, a determination is made as to whether a physical scan of the package has occurred in the past three days. The timeframe chosen for the last physical scan of the package in block 1320 may vary. The timeframe may be more or less than three days, the timeframe may be related to a service standard of the class of mail (e.g., the timeframe may be longer for USPS Marketing Mail). Additionally, an alternative to a physical scan may be used at block 1320. For example, an automated determination of the package's location may be used, and may be obtained by various means including but not limited to an automated camera system capable of identifying the package, or a location tracking device affixed to the package or the package label (e.g., RFID, Bluetooth, etc.).

When a physical scan of the package is determined to have occurred in the past three days at block 1320, the severely delayed packages in transit analyzer 235 moves to block 1325, and the package is not counted.

When a package is determined to be First Class mail at block 1310, the severely delayed packages in transit analyzer 235 moves to block 1315. At block 1315, a determination is made as to whether a physical scan of the package has occurred in the past four days. The timeframe chosen for the last physical scan of the package in block 1320 may vary. The timeframe may be more or less than three days, the timeframe may be related to a service standard of the class of mail (e.g., the timeframe may be longer for USPS Marketing Mail). Additionally, an alternative to a physical scan may be used at block 1315. For example, an automated determination of the package's location may be used and may be obtained by various means including but not limited to an automated camera system capable of identifying the package, or a location tracking device affixed to the package or the package label (e.g., RFID, Bluetooth, etc.).

When a physical scan of the package is determined to have occurred in the past three days at block 1315, the severely delayed packages in transit analyzer 235 moves to block 1335, and the package is not counted. Because items having a high service standard, such as first class require prompt action, identifying delays in first class items can be leading indicator or a barometer to identify where or when large delays or inefficiencies may develop or are developing.

When a physical scan of the package is determined not to have occurred in the past four days at block 1315 or when a physical scan of the package is determined not to have occurred in the past three days at block 1320 the severely delayed packages in transit analyzer 235 moves to block 1330. At block 1330, the package's scheduled delivery date is compared to the current date to determine whether the package is two or more days past scheduled delivery. While two or more days is the timeframe used in this example, other timeframes may be used (e.g., three or more days past scheduled delivery). If the package is determined not to be two or more days past scheduled delivery, the severely delayed packages in transit analyzer 235 moves to block 1335 and the package is not counted.

When a package is determined to be two or more days past scheduled delivery at block 1330, the severely delayed packages in transit analyzer 235 moves to block 1340. At block 1340, the severely delayed packages in transit analyzer 235 proceeds based on whether the package is a Priority or First-Class return. If the package is a Priority or First-Class return, the severely delayed packages in transit analyzer 235 moves to block 1325 and the package is not counted. If the package is not a Priority or First-Class return, the severely delayed packages in transit analyzer 235 moves to block 1345.

At block 1345, the total number of severely delayed packages in transit is counted. The total number of severely delayed packages in transit may be added together. In some embodiments, the total number of severely delayed packages in transit may be separated by class of service, scheduled delivery date, date of receipt of the package by the logistics network, or in any other way which may be useful for further analysis. At block 1350, a performance indicator is assigned to the number of severely delayed packages in transit. The performance indicator may be assigned based on a fixed or dynamic threshold. The value of the threshold may be determined, for example, based on a historical number of severely delayed packages in transit, an expected number of severely delayed packages in transit, a relative comparison of the number of severely delayed packages in transit between delivery facilities on the same or different days where the delivery facilities may or may not be similar, or in any other manner which produces a useful threshold.

In some embodiments, another KPI can be the number of inbound first class parcels The system 100 in block 1310 can determine how many parcels for a certain facility are first class, and can use that number to evaluate for potential issues, delays, or gridlock. As first class parcels are a leading indicator, when the number of first class parcels is high, the system 100 can initiate corrective actions as described herein. A First Class parcel inbound volume can include the number of First Class parcels that have received an acceptance scan, but which have not yet received a processing scan at the destinating facility. Table 10 illustrates ranges and values for this KPI.

TABLE 10

| Range (number of items) | Assessment | Points Assigned |
|---|---|---|
| >30,000 | Contingency | 40 |
| 25,000-30,000 | Mitigation | 30 |
| 20,000-25,000 | Elevated | 20 |
| 10,000-20,000 | Normal | 10 |
| 0-10,000 | Low | 0 |

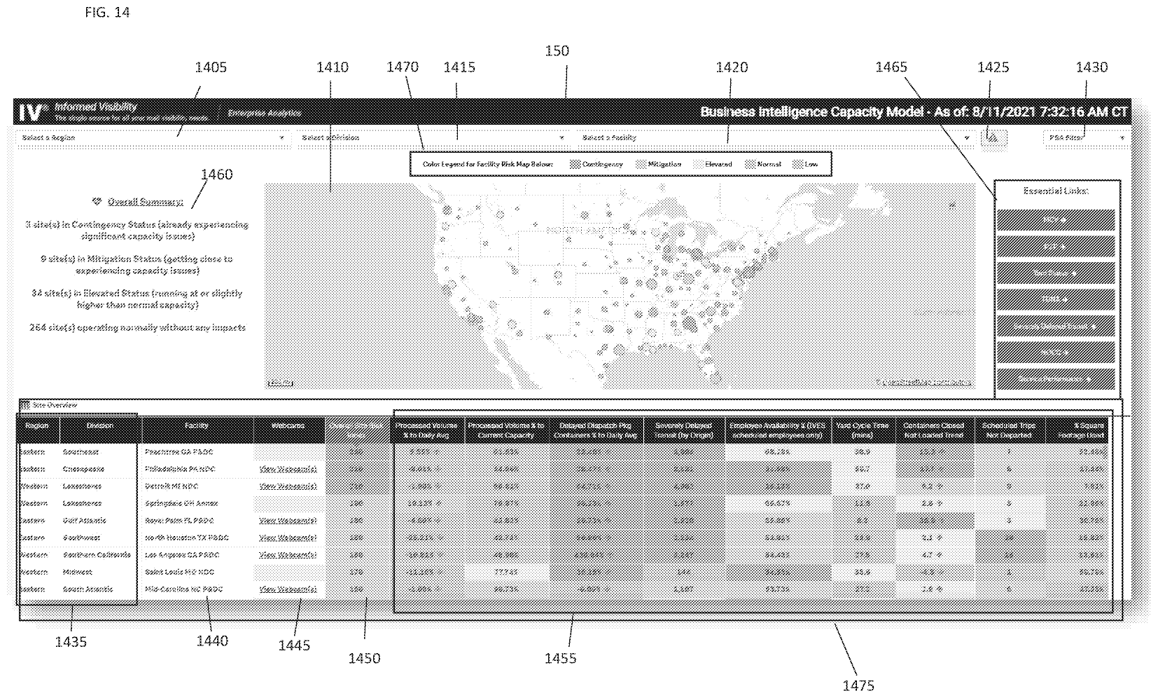

FIG. 14 is an example view of the interactive dashboard 150 for system 100 comprising a user interface. The interactive dashboard 150 may be viewed in a web browser (e.g., Chrome, Firefox, Microsoft Edge, etc.), a special purpose application designed to be executed and displayed on a general-purpose computing device running an operating system (e.g., Linux, Microsoft Windows, etc.), a mobile application or otherwise on a mobile device, or on a limited-purpose device (e.g., a mail scanner). The interactive dashboard 150 may display additional options (e.g., additional filters, additional key performance indicators, additional map views, etc.) not shown in FIG. 14. Additional options may, for example, be shown based on a user input indicating a request for additional information, a user input requesting to zoom in or zoom out on the map display, or as part of a contextual display based on a key performance indicator or facility status.

Region filter 1405 is a dropdown menu allowing a user to limit the information displayed by the interactive dashboard 150 to facilities in one or more specific regions of the logistics network. The regions may be described with respect to cardinal directions (e.g., South, North, North-West, etc.), state names (e.g., Arizona, California, Texas, etc.), zone names (e.g., Zone 1, Zone 2, Zone A, etc.), postal code (90210, 14260, etc.), or using any other description of delivery regions used by the logistics network. The region filter 1405 shown here is a dropdown menu, but other types of selection menus may be used. For example, a checkbox menu, a text box where a user may enter the name of the selected region, or a list allowing for multiple selections.

Division filter 1415 is a dropdown menu allowing a user to limit the information displayed by the interactive dashboard 150 to facilities within one or more divisions. The division filter shown here is a dropdown menu, but other types of selection menus may be used. For example, a checkbox menu, a text box where a user may enter the name of the selected region, or a list allowing for multiple selections.

Facility filter 1420 is a dropdown menu allowing a user to limit the information displayed by the interactive dashboard 150 to one or more named facilities of the logistics network. The facility names may be a city where the facility is located, a part of a county where a facility is located, an area a facility serves, a postal code range a facility serves, a region a facility serves, an arbitrary name, or any other name used to represent a facility of the logistics network. The facility filter 1420 shown here is a dropdown menu, but other types of selection menus may be used. For example, a checkbox menu, a text box where a user may enter the name of the selected region, or a list allowing for multiple selections.

The alert button 1425 is a button which may be used to apply a filter to the interactive dashboard 150 showing facilities for which an alert has been generated. The alert may be triggered automatically or manually. The alert may be the result of a high level of negative KPIs, a determination by system hub 140 that a remedial action plan is required, a determination by system hub 140 that a user approval is needed to implement a remedial action plan, an unexpected situation which may impact the functioning of the facility (e.g., an extreme weather event, a road closure, etc.), or for any other reason a user of system 100 or system hub 140 determines an alert should be issued for a facility. In some embodiments, alert button 1425 may be a menu allowing a user to filter the display of the interactive dashboard 150 based on an alert type (e.g., approval needed for remedial action plan, remedial action plan suggestion needed, etc.).

The PSA filter 1430 may be a filter menu allowing a user of the interactive dashboard 150 to adjust a filter setting of the interactive dashboard 150. For example, the user may indicate a specific facility type (e.g., surface transport centers) on data presented by the interactive dashboard 150 should be filtered, such that the information displayed to the user is associated with the selection indicated by the PSA filter 1430. A filter selected for the PSA filter 1430 may affect the information displayed by the map display 1410, the site overview table 1475, or any other aspect of the interactive dashboard 150.

Map display 1410 may show some or all of the facilities providing information to system 100. The map display 1410 may be limited to displaying only those facilities selected by region filter 1405, division filter 1415, facility filter 1420, PSA filter 1430, or any other filter available on the interactive dashboard 150 in combination or individually. Further, the map display 1410 may provide information about one or more facilities being displayed by the way the facility is represented on the map display 1410. For example, the facility may be displayed as a circle where the size of the circle represents one information about the facility (e.g., current mail volume processed, historical mail volume processed, number of negative KPIs, total value of KPIs, number of ingoing and outgoing connections of a facility, etc.), and the color represents a second information about the facility (e.g., the number of negative KPIs, the current state of the facility, the likelihood of a need for a remedial action plan, the volume of mail being processed, etc.). Additionally, the map display 1410 may only show facilities having a status indicating operation is outside of normal expectations (e.g., a high level of negative KPIs or a negative status level).

Site overview table 1475 is a table displaying information for the facilities of the logistics network. The site overview table 1475 may be sorted based on any column contained therein, for example by overall site risk index displayed in the overall site risk index column 1450. Some columns of the site overview table 1475 may be color coded, some columns of may include hyperlinks used to connect a user of the interactive dashboard 150 to other relevant information, some columns may be hidden automatically or by user input to limit the information displayed, and columns may optionally be manually rearranged by a user of the interactive dashboard 150.

Area information columns 1435 displays information about the location of facilities listed on the interactive dashboard 150. For example, the facility's region, division, service area, or any other information relevant to the facility's location.

Facility column 1440 displays the facility name. Facility column 1445 allows a user to view a display of any webcams located at a facility. The webcam view may be a live view of the webcam updated in real time. In some embodiments, the webcam view may be a still image updated at regular intervals (e.g., every 15 minutes, every 5 minutes, etc.), or at the request of the user. The webcam display may open in a portion of the interactive dashboard 150 or may open a new window, new application, or other window where the webcam image may be viewed.

The overall site risk index column 1450 displays a value representing the site risk index of the displayed facilities. The overall site risk index value is determined by system hub 140 using the KPI information for a delivery facility. The overall site risk index column 1450 may also assign a color to the overall site risk index value. The color may be assigned based on a set of numerical thresholds (e.g., a value over 200 is red, a value from 100 to 199 is orange, etc.).

Facility information display 1455 is a series of columns displaying information about one or more KPIs. The displayed KPIs may be updated at regular intervals (e.g., every 15 minutes, every 5 minutes, every hour, etc.), when a system of a delivery facility monitoring facility performance to assign KPIs assigns a new KPI value (e.g., the delayed package inventory analyzer 245, the average entry to first auto cycle time module 250, etc.), or in response to a user request. The facility information display 1455 may display some or all KPIs tracked for the facilities of the logistics network. The KPIs displayed by the facility information display 1455 may be assigned colors. For example, a KPI that is highly negative (e.g., at risk of needing a remedial action plan, unusually negative, etc.), may be assigned the color red and the cell displaying the KPI value may have a background of that color.

Overall summary information 1460 displays a summary of the functioning of the logistics network. For example, the overall summary information 1460 may display the number of sites in a certain status class (e.g., contingency, mitigation, elevated, normal, etc.). The overall summary information 1460 may also include any information determined to be useful as an overview of the functioning of the logistics network.

Essential links 1465 provides a set of buttons which allow a user to access other systems of the logistics network which may be useful to assessing the functioning of the logistics network or determining an appropriate response to issues experienced by the logistics network. For example, the essential links 1465 may open a new window, new application, or new display within the interactive dashboard 150 allowing the user to access MCV, P2P, Yard Status, TDNA, Severely Delayed Transit, NOCC, Service Performance, or other systems of the logistics network. Additionally, while buttons are shown here, the essential links 1465 may be provided as a hyperlinked text, a menu, or in any other form allowing the user to access the systems of the logistics network.

Color legend 1470 may be provided by the interactive dashboard 150 to inform users of the interactive dashboard 150 of what the facility representations of the map display 1410 are intended to show. For example, the color legend 1470 may inform users that a red circle representing a facility on the map display 1410 indicates the facility is in a contingency state. While colors are indicated in the color legend 1470 here, the color legend 1470 may also indicate other information relevant to allowing a user to understand information displayed by the map display 1410. For example, where a set of shapes are used to indicate information on the map display 1410 (e.g., a square represents a hub facility, a circle represents a delivery facility, etc.), the color legend 1470 may inform the user of the meaning of the shapes.

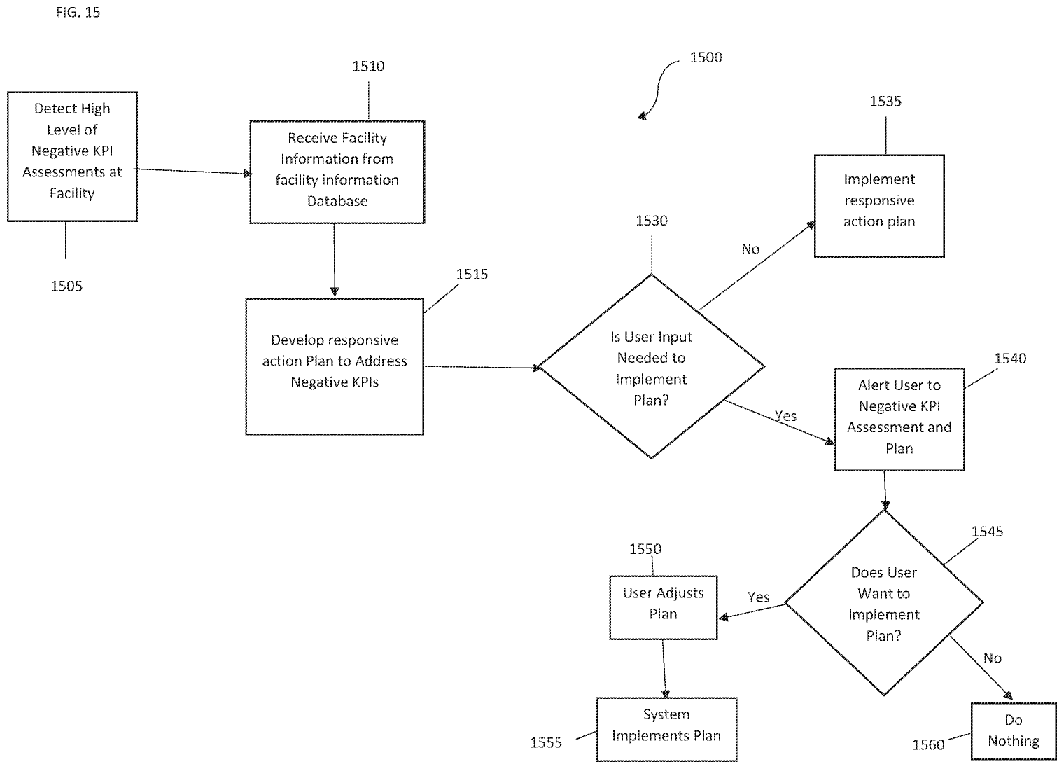

FIG. 15 is an example process flow diagram for a system-generated solutions process 1500, where system hub 140 of system 100 may create and implement a responsive action to one or more negative KPIs at one or more delivery facilities. At block 1505, system hub 140 detects a high level of negative KPIs at one or more delivery facilities. In some embodiments, system hub 140 may be altered to the high level of negative KPIs automatically or manually. In some implementations, system hub 140 may be separate from the system which develops and implements the responsive action. The high level of negative KPIs may be assessed based on a fixed or dynamic threshold, and that threshold may be determined, for example, based on an expected or historical value of expected negative KPIs. The negative KPIs may be entirely from a single delivery facility or from more than one delivery facility. When the negative KPIs come from multiple delivery facilities, the high-level threshold may be determined to be a high number of negative assessments of the same KPI across the multiple facilities, or may be based on a high number of negative assessments of different KPIs across multiple facilities. As discussed above, in some embodiments, a performance indicator may be associated with a numerical value (e.g., a performance indicator of “contingency” may be assigned a value of 40). The system hub 140 may then add the numerical values associated with the performance indicators for a facility, and compare the sum total to a threshold value. In some embodiments, the numerical values may be weighted (e.g., the numerical value associated with the performance indicator may be multiplied by a weight value which results in a higher or lower numerical value), such as when certain KPIs are determined to have a greater effect on the functioning of a facility. The weight values, in some embodiments, may be assigned to each KPI such that the total weighting is equal to one (e.g., the weights 5%, 10%, 25%, 50%, or the like may be assigned to the performance indicators where the system uses three KPIs)When a threshold level of negative KPIs is detected at block 1505, the system-generated solutions process 1500 moves to block 1510. The threshold level may be an overall site risk index value, where the overall site risk index value is determined by combining the values of some or all of the KPIs of the facility. For example, a whole number value may be assigned to an assessed value of each KPI, and the sum of the whole number values may be used to determine the overall site risk (e.g., a value over 200 may be contingency status where a remedial action plan is required). In some embodiments, whole number values assigned to an assessed value of the KPIs may be averaged, and the average may represent the overall site risk index value for the delivery facility (e.g., an average value over 20 may be contingency status where a remedial action plan is required). As discussed above, when determining the overall site risk index value, each KPI may be give equal weighting. In some embodiments, the overall site risk index value may weigh some or all of the KPIs differently. The weighting may be based on the predicted likely impact a KPI has on the performance of the delivery facility. For example, where resource availability is assigned a value of 10 based on the assigned KPI, when adding resource availability to the overall site risk index, it may be given a weight of 1.4, and will therefore be given the value of 14 when added to the overall site risk index. The threshold may be manually set, or automatically set by system hub 140 or another element of system 100. The threshold may be fixed or dynamic, and may be determined based on a past performance or expected performance of the logistics network. For example, a weight table may be stored in the system hub 140 or another component of the system 100. An example weight table is shown below in Table 11A.

TABLE 11A

| Performance Indicator | Weight Value |
|---|---|
| Processed volume % compared to Daily | 5% |
| Average | |
| Average Entry Time to First Auto Cycle | 25% |
| Time | |
| Processed Volume Compared to Current | 5% |
| Capacity | |
| Delayed package inventory by daily average | 10% |
| Inbound FC parcel volume | 5% |
| Resource Availability | 25% |
| Yard Cycle time | 5% |
| Containers Closed Not Loaded trend | 5% |
| Scheduled Trips not Departed | 10% |
| % Square Footage Used | 5% |

The facility information received at block 1510 may also include visual information about a facility, where the visual information may be relevant to the formation of a responsive action plan at block 1515. For example, a snapshot taken at the time the threshold overall site risk index value of block 1505 is passed. In some embodiments, a snapshot image taken every 15 minutes for the hour preceding the threshold being passed, or continuous image data for a limited timeframe preceding the passing of the threshold may be received at block 1510. Optionally, the system-generated solutions process 1500 may skip block 1510 and move directly to block 1515.

At block 1510, the system-generated solutions process 1500 may receive information about the one or more facilities with high levels of negative KPIs, information about other facilities which may be useful in implementing the responsive action plan, and information about facilities which may be impacted directly or indirectly by the responsive action plan. This information may be used at block 1515 as part of the development of a responsive action plan. The information received at block 1510 may include the historical processing volume of the facility, the historical processing volume of equipment, the availability of processing equipment, the availability of transport vehicles, the availability of personnel, the current processing rate of a facility, or any other information relevant to creating and executing a responsive action plan.

Table 11B shows KPI ranking settings for a facility based on weighted or unweighted point values for various KPIs.

TABLE 11B

| Assessment | Points Assigned |
|---|---|
| Contingency | 261-320 |
| Mitigation | 201-260 |
| Elevated | 161-200 |
| Normal | 160 |

When the score for a facility or site is greater than 261, the interface or display may indicate a red highlight on the relevant score, indicating that the facility is in Contingency status, as shown, for example, in FIG. 14. When a facility or site is in contingency status, corrective actions as described elsewhere herein may be undertaken. Similarly, if the facility is in Mitigation status, having a score from 201-260, for example, the display will indicate orange, and the system 100 will take actions according to the mitigation strategy. Elevated may be Yellow, and may require only minor or no corrective actions, and Normal may indicate green, and no corrective actions need to be taken.

At block 1515, available information is used to create a responsive action plan. The system hub 140 may use an artificial intelligence system (e.g., a neural network, a reinforcement learning system, etc.) to determine the appropriate responsive action plan. This artificial intelligence system may be trained on information of the logistics network, individual delivery facilities, information of another logistics network, or any other data useful to train the system to develop responsive action plans. The responsive action plan can involve many actions. Examples of actions which may be included in a responsive action plan are altering the employee schedule of a delivery facility, transferring resources between delivery facilities, increasing or decreasing the run time of one or more processing machines, moving sorted or unsorted mail between delivery facilities for further processing, moving equipment between delivery facilities, and moving transport vehicles between facilities, increasing the available number of transport vehicles at a facility, diverting transport vehicles intended for one facility to another facility, redirecting outgoing items from a facility which were originally intended for a facility with a high level of negative KPIs, initiating a maintenance action for a piece of equipment (e.g., a cooling system, a lubricating system, and the like), increasing the run speed of one or more pieces of equipment, automatically summoning a delivery resource (e.g., an operator, a forklift, an AGV, or other resource) to move or process a delivery item, redirecting a camera, creating a new routing plan for a certain mail class or item type, and the like. The responsive action plan may address one or more negative KPIs at one or more facilities. The responsive action plan may involve different responsive actions at different facilities.

At block 1530, the system-generated solutions process 1500 determines whether the responsive action plan developed in block 1515 requires input, such as authorization, from a user or administrator of system 100. For example, while system 100 may be able to adjust resource scheduling without user input, user input may be required to reassign delivery equipment (e.g., trucks) or to communicate with a delivery partner of the logistics network. If user input is not required, the system-generated solutions process 1500 moves to block 1535, and system 100 implements the responsive action plan across the logistics network. If user input is required, the system-generated solutions process 1500 moves to block 1540.

At block 1540, a user or administrator of the system (e.g., a manager authorized to interact with system 100 and make adjustments which system 100 is not permitted to) is alerted to the responsive action plan. The alert may include details of the responsive action plan sufficient for the user to determine the actions the user is required to take to implement the plan, and any other information related to the responsive action plan which system 100 may implement or which system 100 has already implemented. The details of the plan may include such information as a timeframe for implementation, a timeframe during which corrective action will occur (e.g., information related to the time required to move delivery vehicles between facilities), a timeframe during which the responsive action plan is expected to be effective, expected impacts of implementing the responsive action plan, or any other information which may aid the user in determining whether to allow implementation of the responsive action plan. Additionally, in some scenarios a single user may not have authorization within the logistics network to allow all aspects of the responsive action plan to be implemented, in this case an alert with some or all of the information regarding the responsive action plan may be sent to more than one user. Optionally, the alert to the user may include information about the one or more negative KPIs being addressed by the responsive action plan, the causes of the one or more negative KPIs as determined by system hub 140, the expected level of one or more KPIs following the implementation of the responsive action plan which may include more or less KPIs than are being addressed by the responsive action plan, or any other information which may be useful to the user in determining the potential effectiveness of the responsive action plan in addressing the one or more negative KPIs.

At block 1545, the user communicates with system 100, for example through system hub 140 or the user device alert system 120. The user may give permission to system hub 140 to implement some or all elements of the responsive action plan for which permission of the user was requested. When the user denies permission to implement some or all of the responsive action plan, the system-generated solutions process 1500 moves to block 1560 and system 100 does nothing and awaits further instructions.

When the user provides permission for system 100 to implement the responsive action plan, the system-generated solutions process 1500 may optionally move to block 1550. At block 1550, the user may make adjustments to the responsive action plan proposed by system hub 140. For example, where the responsive action plan includes moving ten delivery vehicles from one facility to another facility, the user may change the number of vehicles to 8. In another example, where the responsive action plan recommends increasing the run speed of a piece of processing equipment at a delivery facility for four hours, the user may increase the time to six hours. Users may be permitted to adjust some or all aspects of the responsive action plan, which may include allowing the user to make changes to portions of the responsive action plan for which permission of the user was not needed.

At block 1555, system 100 implements the responsive action plan. The implementation may include adjustments made by one or more users at block 1550. The implementation may involve direct alerts to affected individuals or groups, updates to automated systems connected to system hub 140, or changes to any other system to which system hub 140 has access.

Other KPIs can have Ranges and Assements, and points assigned to be analyze as described similar to the other KPIs described herein. Table 12 shows the values for the Average Trailer Unload Cycle time.

TABLE 12

| Range (in Minutes) | Assessment | Points Assigned |
|---|---|---|
| >53 | Contingency | 40 |
| >38-53 | Mitigation | 30 |
| >23-38 | Elevated | 20 |
| >8-23 | Normal | 10 |
| 8 or fewer | Low | 0 |

Table 13 shows the values for the Average Container Dwell time KPI.

TABLE 13

| Range (in hours) | Assessment | Points Assigned |
|---|---|---|
| >7 | Contingency | 40 |
| 6-7 | Mitigation | 30 |
| 5-6 | Elevated | 20 |
| 4-5 | Normal | 10 |
| 4 or less | Low T | 0 |

Table 14 shows values for the surface transfer center exceptions.

TABLE 14

| Range (in Minutes) | Assessment | Points Assigned |
|---|---|---|
| >80 | Contingency | 40 |
| 60-80 | Mitigation | 30 |
| 40-60 | Elevated | 20 |
| 20-40 | Normal | 10 |
| 20 or less | Low | 0 |

Table 15 shows the values for an estimated containers in the building KPI.

TABLE 15

| Range | Assessment | Points Assigned |
|---|---|---|
| 800 | Contingency | 40 |
| 600-800 | Mitigation | 30 |
| 400-600 | Elevated | 20 |
| 200-400 | Normal | 10 |
| 200 or less | Low | 0 |

Table 16 shows the values for the containers older than 24 hours KPI.

TABLE 16

| Range (in Minutes) | Assessment | Points Assigned |
|---|---|---|
| >200 | Contingency | 40 |
| 150-200 | Mitigation | 30 |
| 100-150 | Elevated | 20 |
| 50-100 | Normal | 10 |
| 50 or less | Low | 0 |

The KPIs in Tables 12-16 can be used as described above with regard to certain facilities, such as surface transfer facilities. When the score for a surface transfer facility is high, then

Throughout the preceding description, reference may be made to various timeframes, for example a number of hours, minutes, weeks, or days, to aid in describing the various example systems, processes, and methods. Such timeframes may differ in various implementations, and any timeframe presented should be considered an example only. Additionally, where not discussed explicitly, it should be understood that logistics may be affected by cyclical, annual, or other regular interruptions such as weather, holidays, timeframes with increased incidence of illness, etc. These interruptions may be factored into the various timeframes discussed, for example a delivery day occurring on a holiday may be compared to previous holidays even where another timeframe is otherwise discussed, or a holiday may be excluded from a timeframe.

The various illustrative logical blocks, modules, routines, and algorithm steps described in connection with the embodiments disclosed herein can be implemented as electronic hardware, or as a combination of electronic hardware and executable software. To clearly illustrate this interchangeability, various illustrative components, blocks, modules, and steps have been described above generally in terms of their functionality. Whether such functionality is implemented as specialized hardware, or as specific software instructions executable by one or more hardware devices, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A system can be or include a microprocessor, but in the alternative, the system can be or include a controller, microcontroller, or state machine, combinations of the same, or the like configured to generate and analyze indicator feedback. An system can include electrical circuitry configured to process computer-executable instructions. Although described herein primarily with respect to digital technology, a system may also include primarily analog components. For example, some or all of the features described herein may be implemented in analog circuitry or mixed analog and digital circuitry. A computing environment can include a specialized computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in specifically tailored hardware, in a specialized software module executed by a system, or in a combination of the two. A software module can reside in random access memory (RAM) memory, flash memory, read only memory (ROM), erasable programmable read-only memory (EPROM), electrically erasable programmable read-only memory (EEPROM), registers, hard disk, a removable disk, a compact disc read-only memory (CD-ROM), or other form of a non-transitory computer-readable storage medium. An exemplary storage medium can be coupled to the system such that the system can read information from, and write information to, the storage medium. In the alternative, the storage medium can be integral to the system. The system and the storage medium can reside in an application specific integrated circuit (ASIC). The ASIC can reside in an access device or other monitoring device. In the alternative, the system and the storage medium can reside as discrete components in an access device or other item processing device. In some embodiments, the method may be a computer-implemented method performed under the control of a computing device, such as an access device or other item processing device, executing specific computer-executable instructions.

Conditional language used herein, such as, among others, “can,” “could,” “might,” “may,” “e.g.,” and the like, unless specifically stated otherwise, or otherwise understood within the context as used, is generally intended to convey that certain embodiments include, while some embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each is present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

As used herein, the terms “determine” or “determining” encompass a wide variety of actions. For example, “determining” may include calculating, computing, processing, deriving, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

As used herein, the term “selectively” or “selective” may encompass a wide variety of actions. For example, a “selective” process may include determining one option from multiple options. A “selective” process may include one or more of: dynamically determined inputs, preconfigured inputs, or user-initiated inputs for making the determination. In some embodiments, an n-input switch may be included to provide selective functionality where n is the number of inputs used to make the selection.

As used herein, the terms “provide” or “providing” encompass a wide variety of actions. For example, “providing” may include storing a value in a location for subsequent retrieval, transmitting a value directly to the recipient, transmitting or storing a reference to a value, and the like. “Providing” may also include encoding, decoding, encrypting, decrypting, validating, verifying, and the like.

As used herein, the term “message” encompasses a wide variety of formats for communicating (e.g., transmitting or receiving) information. A message may include a machine-readable aggregation of information such as an XML document, fixed field message, comma separated message, or the like. A message may, in some embodiments, include a signal utilized to transmit one or more representations of the information. While recited in the singular, it will be understood that a message may be composed, transmitted, stored, received, etc. in multiple parts.

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it covers all modifications and alternatives coming within the true scope and spirit of the invention as embodied in the attached claims.

What is claimed is:

1. A system comprising:
a database comprising a key performance indicator associated with a facility;
a memory storing computer-executable instructions;
one or more processors in communication with the memory, wherein the computer-executable instructions when executed by the one or more processors cause the one or more processors to:
receive, from the database, the key performance indicator;
process the key performance indicator to assign a site risk index of the facility by comparing the key performance indicator to an expected value;
determine, based on the site risk index, a requirement to implement an action plan associated with a facility issue;
generate, based on the key performance indicator and the site risk index, the action plan comprising a remedial action, wherein the action plan corrects the facility issue; and
transmit the remedial action to an equipment of the facility, wherein the remedial action comprises an action performable by the equipment.

2. The system of claim 1, wherein the one or more processors are further configured to automatically instruct the equipment to alter one or more operations in response to the determined site risk index.

3. The system of claim 2, wherein the response further comprises a user approval and user adjustment associated with the action plan; and wherein the one or more processors are further programmed by the computer-executable instructions to modify the action plan based on the user adjustment.

4. The system of claim 1, wherein the one or more processors are further programmed by the computer-executable instructions to:
receive, from the database, an updated key performance indicator associated with the facility responsive to the remedial action;
process the updated key performance indicator to assign an updated site risk index of the facility by comparing the updated key performance indicator to the expected value;
determine, based on the updated site risk index, a need to implement an updated action plan;
generate, based on the updated site risk index and the updated key performance indicator, the updated action plan; and
transmit the updated action plan to the equipment.

5. The system of claim 1, wherein the database comprises a plurality of key performance indicators, each key performance indicator of the plurality of key performance indicators associated with at least one of a plurality of facilities.

6. The system of claim 1, wherein the one or more processors are further programmed by the computer-executable instructions to:
transmit an alert to a user, the alert comprising an indication that the remedial action has been transmitted to the equipment.

7. The system of claim 1, wherein the action plan is generated based in part on a previously implemented action plan.

8. The system of claim 1 further comprising a plurality of equipment associated with the facility, the plurality of equipment in communication with the database.

9. The system of claim 1, wherein the site risk index indicates a likelihood of a delay in the processing of mail by the facility.

10. A method comprising:
receiving, from a database, a key performance indicator associated with a facility;
processing the key performance indicator to assign a site risk index of the facility by comparing the key performance indicator to an expected value;
determining, based on the site risk index, a need to implement an action plan to correct a facility issue;
generating, based on the key performance indicator and the site risk index, the action plan comprising a remedial action to correct the facility issue;
transmitting the remedial action to item processing equipment of the facility; and
causing the equipment to implement the remedial action.

11. The method of claim 10 further comprising:
receiving, at the database, an information item from a facility equipment; and
generating, based at least on the information item, the key performance indicator.

12. The method of claim 10 further comprising:
generating, based at least on the site risk index and the key performance indicator, a user interface comprising the site risk index and the key performance indicator; and
presenting the user interface on a display.

13. The method of claim 12 further comprising:
receiving via the user interface a user indication;
adjusting the action plan in response to the user indication by changing the remedial action to create an updated remedial action;
transmitting the updated remedial action to the equipment; and
causing the equipment to implement the updated remedial action.

14. The method of claim 12 further comprising:
receiving a response from the equipment indicating performance of the remedial action; and
updating the user interface based on the response.

15. The method of claim 12 further comprising:
receiving, via the user interface, a user request comprising a request to display information of a second facility;
receiving, from a second database, a second key performance indicator associated with the second facility;
processing the second key performance indicator to assign a second site risk index of the second facility by comparing the second key performance indicator to a second expected value; and
causing the user interface to display the second site risk index and the second key performance indicator.

16. The method of claim 15 wherein the facility is of a first facility type and wherein the second facility is of a second facility type.

17. The method of claim 10 wherein the site risk index is a weighted score determined from a plurality of key performance indicators representing a current status of the facility.

18. The method of claim 10 wherein the facility is one of a network distribution center or a surface transfer center.

19. The method of claim 10 wherein the key performance indicator is an average container dwell time of the facility, and the method further comprising:
receiving from a camera of the facility a first image of the facility representing a location;
identifying a plurality of trailers in the first image;
determining a location of each of the plurality of trailers;
receiving from the camera a second image of the facility, wherein the second image comprises image information of substantially the location as represented in the first image;
identifying a second plurality of trailers in the second image;
determining the location of each of the second plurality of trailers;
comparing each trailer of the plurality of trailers to each trailer of the second plurality of trailers to generate a first result;
comparing the location of each trailer of the plurality of trailers to each trailer of the second plurality of trailers to generate a second result;
determining a number of trailers closed not loaded;
assessing the number of trailers closed not loaded to a historical trailers closed not loaded to create a trend value;
generating the key performance indicator based on the trend value; and
storing the key performance indicator in the database.

20. The method of claim 10 wherein causing the equipment to implement the remedial action comprises automatically summoning an automated guided vehicle to pick up and move a container at the facility.
